(19) United States
(12) Patent Application Publication
(10) Pub. No.: US 2020/0331026 A1
(43) Pub. Date: Oct. 22, 2020

(54) METHODS FOR IMPROVED ADHESION OF A COATING TO A SUBSTRATE SURFACE AND ARTICLES MADE THEREFROM

(71) Applicant: INTERNATIONAL PAPER COMPANY, Memphis, TN (US)

(72) Inventors: Sadakat Hussain, Memphis, TN (US); David Eugene Phillips, JR., Haughton, LA (US); Dennis Bruce Crawshaw, Mason, OH (US); Matthew John Bachus, West Chester, OH (US)

(21) Appl. No.: 16/850,255

(22) Filed: Apr. 16, 2020

Related U.S. Application Data
(60) Provisional application No. 62/835,088, filed on Apr. 17, 2019.

(51) Int. Cl. B05D 7/00; B65D 5/28; B65D 5/20; C09D 191/06; B05D 3/12; C09D 11/10

(52) U.S. Cl. CPC B05D 7/50; B65D 5/28; B65D 5/2076; B05D 2518/00; B05D 3/12; C09D 11/10; B05D 2201/02; C09D 191/06

(57) ABSTRACT

A method including providing a substrate including a substrate surface with a first surface free energy; treating one or more sections of the substrate surface by applying a coating including an ink and/or at least one ink component; and applying a wax coating to at least one of the one or more treated sections of the substrate surface, in which the wax coating has a second surface free energy and the coating including the ink and/or ink component has a third surface free energy that is greater than the second surface free energy such that adhesion of the wax coating to the treated sections of the substrate surface is increased. Also provided is an article formed from a treated substrate.

### CROSS-REFERENCE TO RELATED APPLICATIONS

This application claims the benefit of U.S. Provisional Application No. 62/835,088, filed Apr. 17, 2019, the entirety of which is hereby incorporated by reference.

### FIELD OF THE INVENTION

This invention relates generally to coating of a substrate surface. More particularly, the invention relates to methods for preparing a substrate to be coated that exhibits improved adhesion between the coating and the substrate surface and articles made therefrom.

### BACKGROUND OF THE INVENTION

Many products, including food products, that comprise a liquid or semi-liquid content may be stored and/or transported in containers comprising paperboard that has been coated with one or more materials comprising, for example, a wax or resin. The coating increases water resistance and provides a barrier against ingress of water, other liquids, and/or vapor into the paperboard from the product inside the container, as well as from storage and transportation of the container in a wet or humid environment. The coating helps to maintain the strength and integrity of the container for a longer period of time.

During manufacture, one or more coatings may be applied to an inner and/or outer surface of the container, which may be in a fully or partially flattened state. An adhesive may be applied to the container, e.g., to one or more flaps, and the flaps may be adhered to each other or to other portions of the container to form one or more joints and to at least partially erect the container. The joints are subjected to various forces, such as internal pressure from a product placed inside the container and forces exerted on the outside of the container from adjacent containers, impacts, etc. As a result, the flaps may come apart and one or more of these joints may fail, causing the container to at least partially open. Failure of one joint may lead to failure of other joints or other portions of the container, particularly when the product comprises a heavy, semi-liquid or flowable product such as meat or fish. Joint failure may be intensified by the presence of wax and other materials that may interfere with adhesion of the adhesive to the paper.

In addition, recycling of containers coated with a petroleum based paraffin wax or other similar materials is frequently limited due to the costly equipment, time, and labor required for repulping the coated containers and cleaning of the resulting pulp to prevent wax carryover. Thus, rather than being recycled, coated containers are often incinerated or discarded in landfills.

### SUMMARY OF THE INVENTION

In accordance with an aspect of the disclosure, a method is provided, the method including: providing a substrate including a substrate surface with a first surface free energy; treating one or more sections of the substrate surface by applying a coating including one or more of an ink or at least one ink component; and applying a wax coating to at least one of the one or more treated sections of the substrate surface, in which the wax coating has a second surface free energy and in which the coating including one or more of an ink or at least one ink component has a third surface free energy that is greater than the second surface free energy such that treating the one or more sections of the substrate surface increases adhesion of the wax coating to the treated sections of the substrate surface.

The substrate may include a cellulose-based substrate.

The one or more ink components may include one or more of an extender and a resin.

The first surface free energy may include a first total surface free energy that is a sum of a first polar component and a first dispersive component, in which a first percent polarity is a percentage of the first total surface free energy including the first polar component; the second surface free energy may include a second total surface free energy that is a sum of a second polar component and a second dispersive component, in which a second percent polarity is a percentage of the second total surface free energy including the second polar component; and the third surface free energy may include a third total surface free energy that is a sum of a third polar component and a third dispersive component, in which a third percent polarity is a percentage of the third total surface free energy including the third polar component, in which the second percent polarity may be between the first percent polarity and the third percent polarity.

The substrate may include a cellulose-based substrate with an inner surface, an outer surface, and one or more overlap areas, in which each of the one or more overlap areas may be defined by a first portion of one of the inner surface or the outer surface that overlaps with a second portion of the other of the inner surface or the outer surface and in which the one or more sections may include at least one of the first or the second portion of the one or more overlap areas.

In some examples, the coating including one or more of an ink or at least one ink component may be applied to substantially an entirety of the at least one of the first or the second portion of the one or more overlap areas. In other examples, following application of the wax coating, the method may further include applying an adhesive coating to one of the first or the second portion of at least one of the one or more overlap areas. In some particular examples, following application of the adhesive coating, the method may further include folding the substrate such that the one of the first or the second portion of the at least one overlap area including the adhesive coating overlaps and adheres to the other of the first or the second portion of the at least one overlap area to form a joint, in which a bond strength of the joint may be greater than about 2.5 pounds of force per inch. In further examples, the wax coating may cover substantially an entirety of at least one of the inner surface or the outer surface.

The second surface free energy may be substantially similar to or less than the first surface free energy.

The wax coating may include a bio-based wax, a paraffin wax, or blends thereof.

In some examples, treating the one or more sections of the substrate surface may further include mechanically abrading the one or more sections of the substrate surface.

In accordance with another aspect of the disclosure, an article is provided, the article including: a substrate with a substrate surface, in which one or more sections of the substrate surface are treated by applying a layer including one or more of an ink or at least one ink component; and a wax layer positioned on at least one of the one or more treated sections of the substrate surface, in which: the substrate surface has a first surface free energy prior to treatment; the wax coating has a second surface free energy; and the coating including one or more of an ink or at least one ink component has a third surface free energy that is greater than the second surface free energy such that treating the one or more sections of the substrate surface increases adhesion of the wax coating to the treated sections of the substrate surface.

The substrate may include a cellulose-based substrate.

The one or more ink components may include one or more of an extender and a resin.

The first surface free energy may include a first total surface free energy that is a sum of a first polar component and a first dispersive component, in which a first percent polarity is a percentage of the first total surface free energy including the first polar component; the second surface free energy may include a second total surface free energy that is a sum of a second polar component and a second dispersive component, in which a second percent polarity is a percentage of the second total surface free energy including the second polar component; and the third surface free energy may include a third total surface free energy that is a sum of a third polar component and a third dispersive component, in which a third percent polarity is a percentage of the third total surface free energy including the third polar component, in which the second percent polarity may be between the first percent polarity and the third percent polarity.

The substrate may include a cellulose-based substrate with an inner surface, an outer surface, and one or more overlap areas, in which each of the one or more overlap areas may be defined by a first portion of one of the inner surface or the outer surface that overlaps with a second portion of the other of the inner surface or the outer surface and in which the one or more sections may include at least one of the first or the second portion of the one or more overlap areas.

In some examples, the layer including one or more of an ink or at least one ink component may be positioned on substantially an entirety of the at least one of the first or the second portion of the one or more overlap areas. In other examples, the article may further include an adhesive layer positioned on one of the first or the second portion of at least one of the one or more overlap areas and located on top of the wax layer. In some particular examples, the article may further include one or more joints formed by the one of the first or the second portion of the at least one overlap area including the adhesive layer that overlaps and adheres to the other of the first or the second portion of the at least one overlap area, in which a bond strength of the joint may be greater than about 2.5 pounds of force per inch. In further examples, the wax layer may be positioned on substantially an entirety of at least one of the inner surface or the outer surface.

The second surface free energy may be substantially similar to or less than the first surface free energy.

The wax layer may include a bio-based wax, a paraffin wax, or blends thereof.

In some examples, treatment of the one or more sections of the substrate surface may further include mechanically abrading the one or more sections of the substrate surface.

In other examples, the article may include a container for a food item.

### BRIEF DESCRIPTION OF THE DRAWINGS

While the specification concludes with claims particularly pointing out and distinctly claiming the present invention, it is believed that the present invention will be better understood from the following description in conjunction with the accompanying Drawing Figures, in which like reference numerals identify like elements, and wherein:

FIG. 1 is a plan view of a blank for forming an article, in accordance with the present disclosure;

FIG. 2A is a perspective view of the blank of FIG. 1 that has been partially assembled;

FIG. 2B is a perspective view of the fully assembled container;

FIG. 3 is a cross-sectional view of the blank of FIG. 1 taken along line 3-3;

FIGS. 4A and 4B are cross-sectional views of a portion of the container of FIG. 2B taken along line 4-4;

FIGS. 5A to 5H are top, plan views of a portion of a substrate surface in accordance with the present disclosure;

FIG. 6A is a diagram of a corona treatment apparatus in accordance with the present

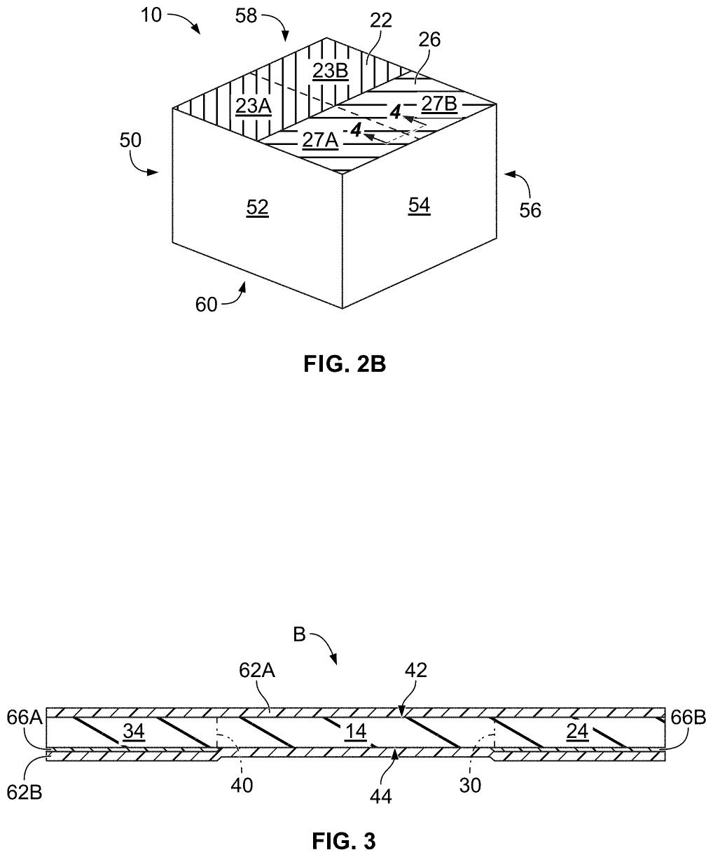

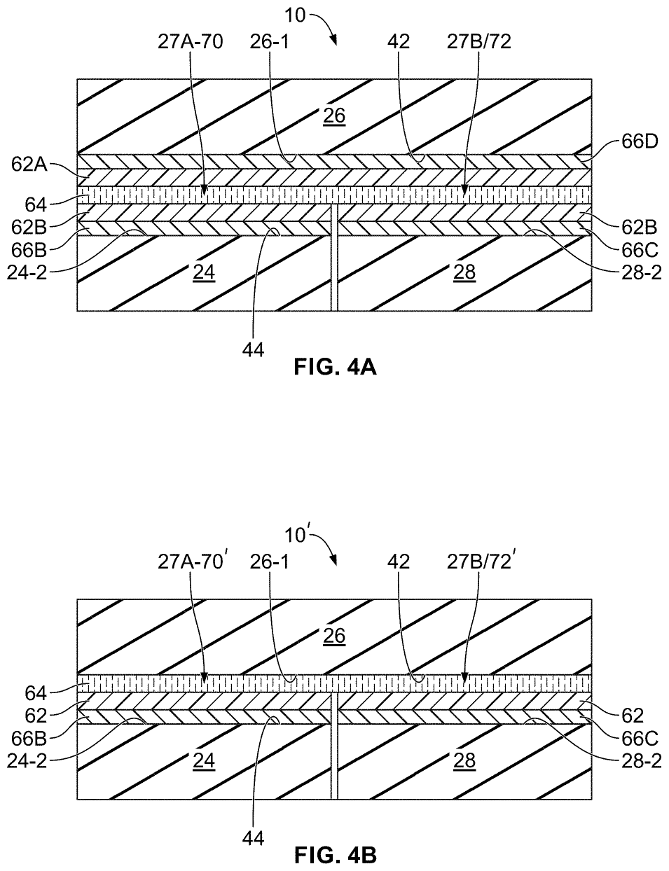

FIGS. 4A and 4B are cross-sectional views of a portion of the container of FIG. 2B taken along line 4-4;

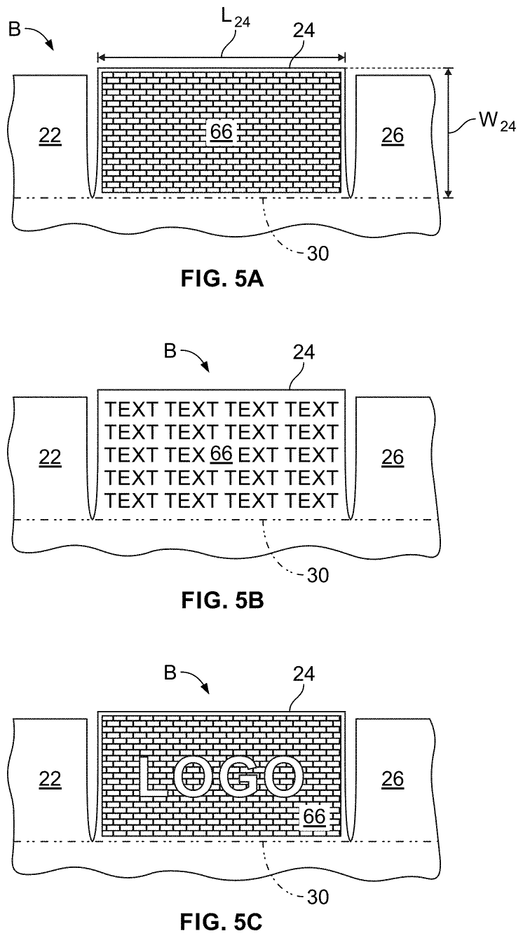

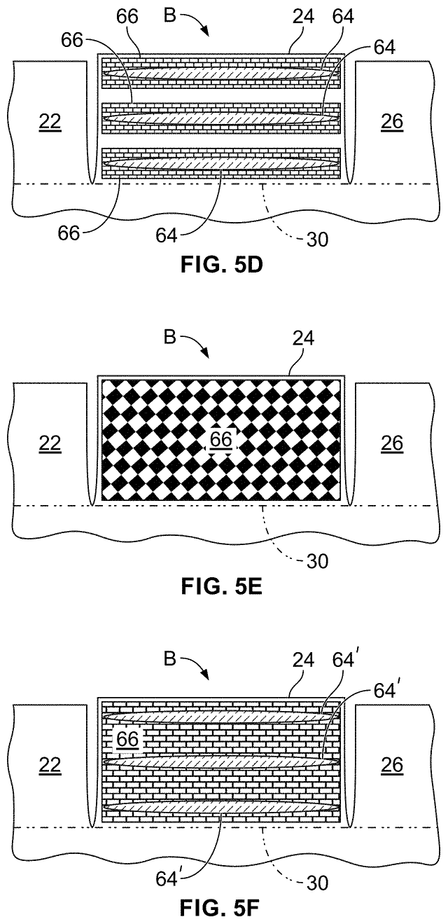

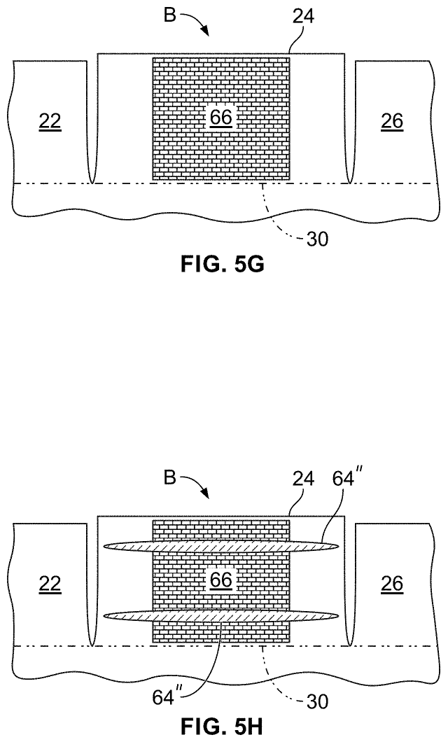

FIGS. 5A to 5H are top, plan views of a portion of a substrate surface in accordance with the present disclosure;

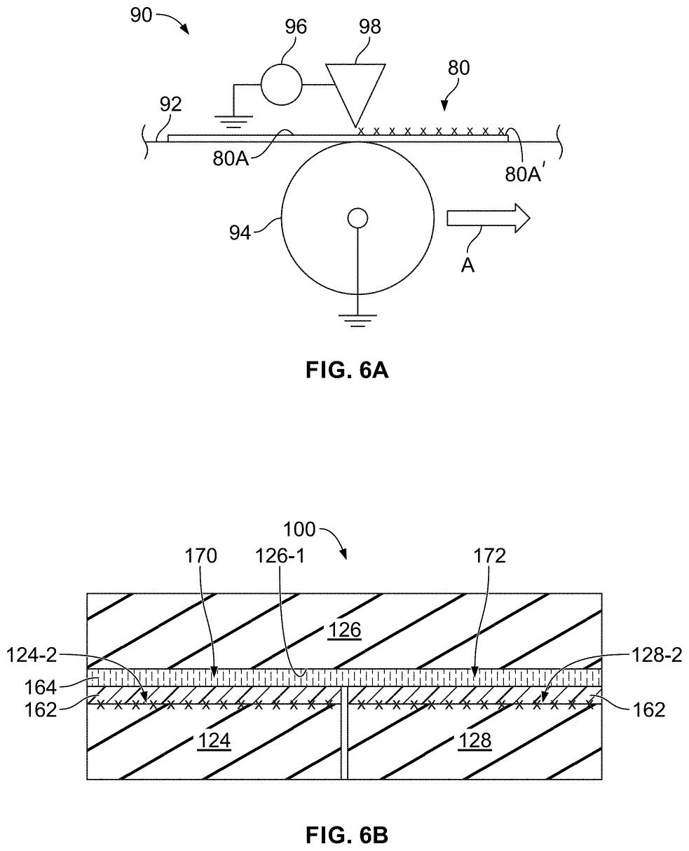

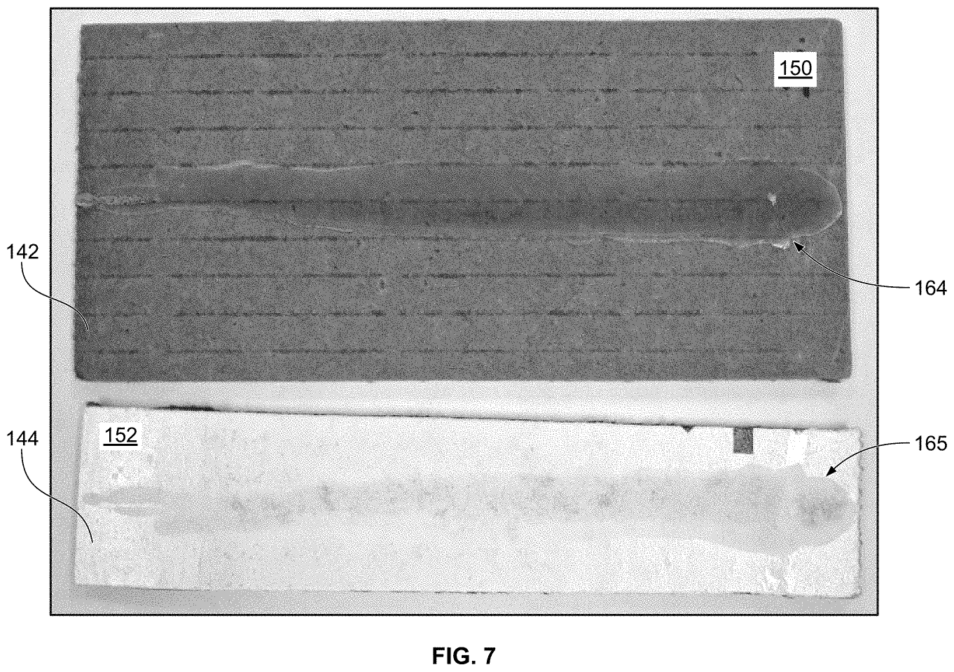

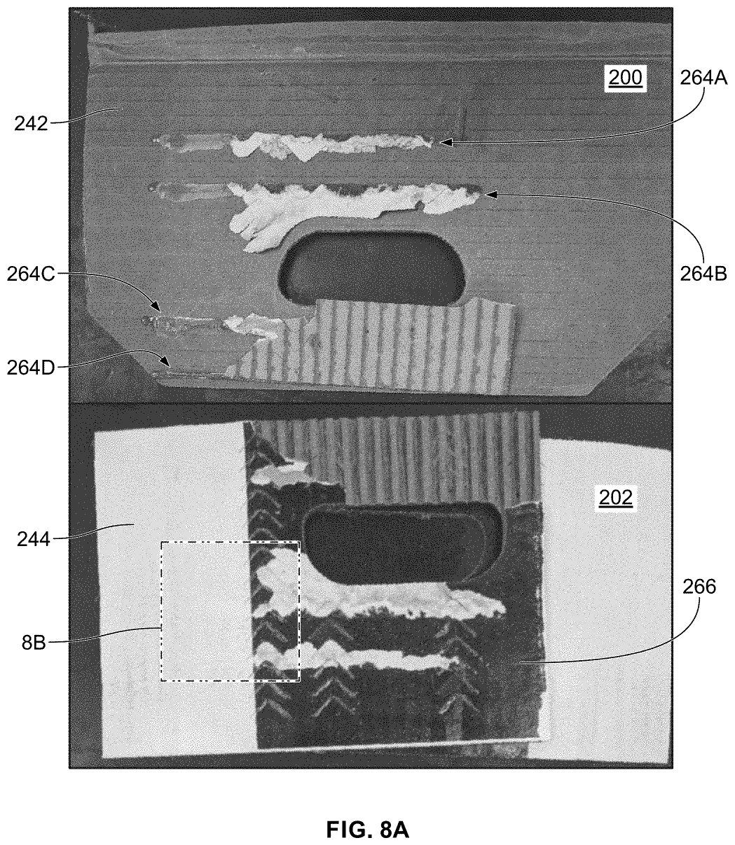

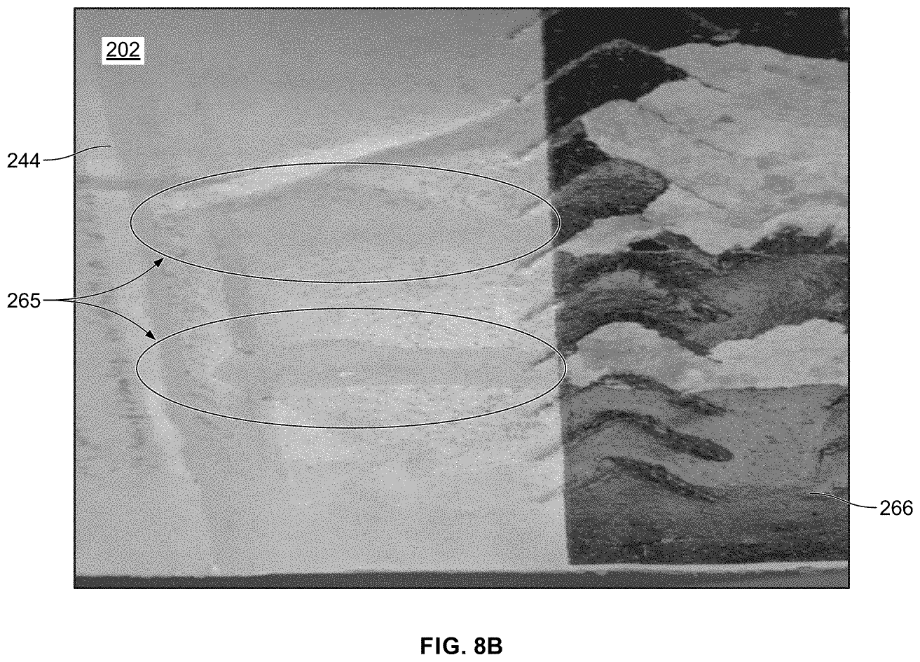

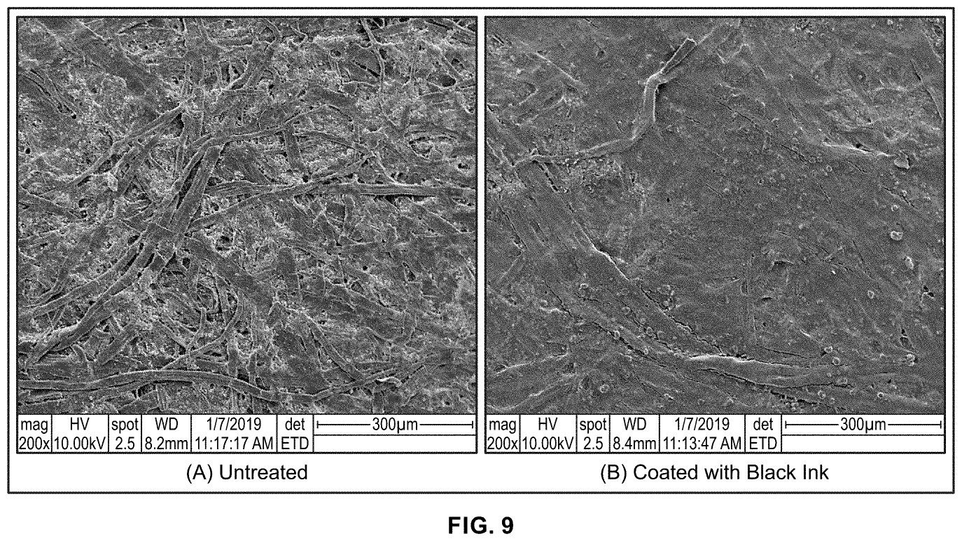

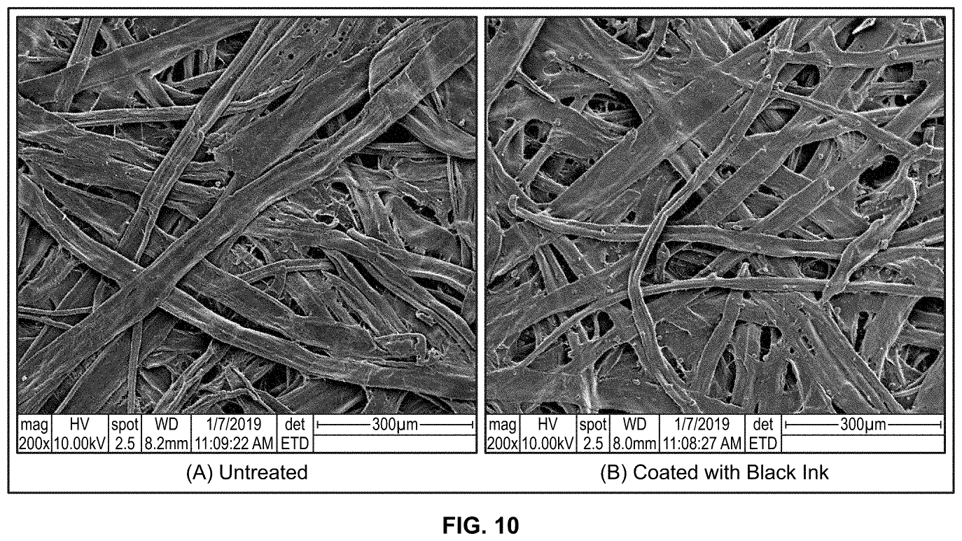

FIG. 6A is a diagram of a corona treatment apparatus in accordance with the present disclosure;

FIG. 6B is a cross-sectional view similar to FIGS. 4A and 4B of a container in accordance with the present disclosure;

FIG. 7 is a photograph representing joint failure of a joint formed using known methods;

FIGS. 8A and 8B are photographs representing joint failure of a joint formed in accordance with the present disclosure;

FIG. 9 includes electron micrographs of a portion of an untreated substrate surface and a portion of the substrate surface following application of an ink (200× magnification); and FIG. 10 includes electron micrographs of a portion of another untreated substrate surface and a portion of the substrate surface following application of an ink (200× magnification).

### DETAILED DESCRIPTION OF THE INVENTION

In the following detailed description of the preferred embodiments, reference is made to the accompanying drawings that form a part hereof, and in which is shown by way of illustration, and not by way of limitation, specific preferred embodiments in which the invention may be practiced. It is to be understood that other embodiments may be utilized and that changes may be made without departing from the spirit and scope of the present invention.

The present description is directed to methods for preparing a substrate to be coated and articles manufactured from the substrate to be coated. The articles may comprise, for example, a box or container that may be formed from a blank and may be used to store and/or transport one or more products. In accordance with the present disclosure, one or more sections of a substrate surface may be treated to increase adhesion of the coating(s) to the substrate surface. In the case of container manufacture, this increased adhesion of the coating(s) to the substrate surface may result in an increase in a bond strength of the joints.

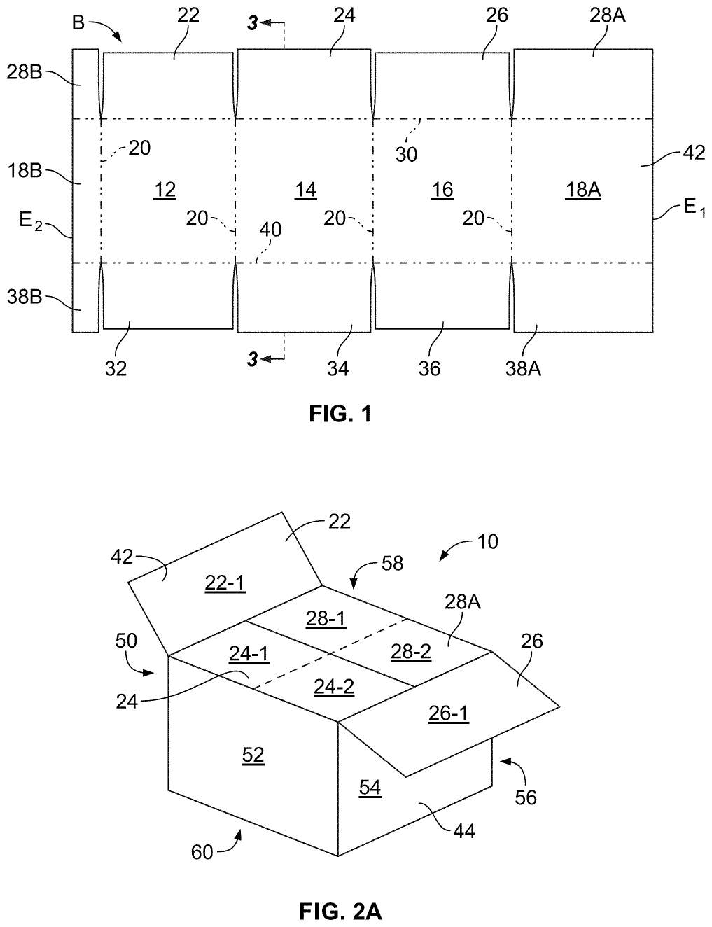

With reference to FIGS. 1, 2A, and 2B, an exemplary substrate is shown, which may comprise a blank B and/or a container 10, which may be formed from the blank B. The blank B may comprise a single, continuous piece of substantially planar material. In some examples, the blank B may comprise a cellulose-based substrate, such as a container board or a paper product such as paper or paperboard. The blank B may comprise an inner surface 42 that is shown facing out of the page in FIG. 1 and an outer surface 44 (not visible in FIG. 1, but is shown in FIG. 2A) is facing an opposite direction from the inner surface 42. While the examples depicted herein relate to containers, it is understood that the substrate may comprise any suitable material or combination thereof and is not limited to any specific field of use or purpose. For example, the substrate may comprise a plastic or a composite material comprising a plastic.

The blank B shown in FIG. 1 comprises a plurality of panels 12, 14, 16, 18A, and 18B connected along fold lines 20. Top flaps 22, 24, 26, 28A, and 28B are foldably joined to edges of respective ones of the wall panels 12, 14, 16, 18A, and 18B along fold line 30 extending perpendicular to the fold lines 20, and bottom flaps 32, 34, 36, 38A and 38B are foldably joined to opposing edges of respective ones of the wall panels 12, 14, 16, 18A, and 18B along fold line 40 extending perpendicular to the fold lines 20. Edge portions of panels 18A, 28A, and 38A form one lateral edge E₁ of the blank B, and edge portions of panels 18B, 28B, and 38B form the other opposing lateral edge E₂ of the blank B. While the example structures depicted in FIGS. 1 and 2 are for forming a container with a substantially square or cube shape, it is understood that the container may define any suitable geometric shape, such as a substantially rectangular, oval, cylindrical, or triangular shape, and combinations thereof, as well as other shapes such as a heart or star shape, and may optionally comprise a lid, one or more cutouts or handles, etc.

FIG. 3 illustrates a cross-sectional view taken along view line 3-3 in FIG. 1 of a portion of the blank B in accordance with the present disclosure. One or more coatings (also referred to herein as a first coating) may be applied to one or more sections of the blank B. For example, coatings 62A and 62B may be applied to one or more portions of the inner and outer surfaces 42, 44 of the blank B, as shown in FIGS. 3 and 4A, and/or a coating 62 may be applied to one or more portions of only one surface, e.g., the outer surface 44, of the blank B, as shown in FIG. 4B. In some examples, the coating(s) 62A, 62B may be applied across only a portion of the respective inner or outer surface 42, 44, and in other examples, the coating(s) 62A, 62B may be applied across an entirety of the respective inner or outer surface 42, 44.

In some instances, the coatings 62A, 62B (may be referred to herein collectively as coating 62) may comprise a wax that, for example, increases the water resistance of the underlying substrate surface. The wax may comprise, for example, a paraffin wax, a bio-based wax, and blends thereof. The paraffin wax may be derived from one or more petroleum sources and may be blended with one or more additional petroleum products or byproducts. The bio-based wax may be derived from one or more biological and/or renewable sources, and may comprise, for example, a mixture of triglycerides, esters, and polymers, in which the triglycerides, esters, and/or polymers may be derived from one or more animal and/or plant sources. In addition to being based on non-petroleum sources, many bio-based waxes are also recyclable. In other instances, the coating 62 may comprise a water-based acrylic coating or a barrier coat or film comprising an epoxy. The coating 62 may be applied using one or more known techniques, such as curtain coating, cascade coating, rod coating, impregnation, pressing such as using a puddle press, size press, or film press, and/or any other suitable technique.

### Treating a Substrate Surface to Alter a Surface Free Energy of the Substrate Surface

In accordance with the present disclosure, one or more sections of the substrate surface may be treated prior to application of the one or more coatings, e.g., coating(s) 62, to the substrate surface to increase adhesion of the one or more coatings to the treated sections of the substrate surface. In some examples, treating the one or more sections of the substrate surface may comprise altering the surface free energy of the one or more treated sections. As used herein, the term “surface free energy” may generally refer to the excess energy that exists at the surface of a solid of a given material (as opposed to an interior of the solid). The molecules at the surface cannot interact with as many neighboring molecules, as compared to molecules located in the interior of the solid, and thus have excess interaction energy. As used herein, the term “surface tension” describes a type of surface free energy with respect to a liquid and may generally be defined as the amount of excess energy at the surface of the liquid, which exists because molecules located in an interior of the liquid are in a lower energy state than molecules at the surface of the liquid. When a material in liquid phase is referred to herein as having a surface free energy, that surface free energy is defined herein to be a surface free energy that has been measured after the liquid material has been applied to another solid surface and solidified, i.e., the surface free energy of the liquid material is defined herein as comprising the surface free energy measured after the material is in a solid state.

In accordance with the present disclosure, treating the one or more sections of the substrate surface may comprise altering the surface free energy of the substrate surface such that it is greater than a surface free energy of the one or more coatings. When applying a coating of a (liquid) material to a solid substrate surface, spreading of the liquid material and wetting of the substrate surface depends on the relative surface energy of the liquid material compared to the surface energy of the substrate surface. It is generally known that if the surface free energy of the liquid exceeds the surface free energy of the substrate surface, the liquid will prefer to maintain a substantially spherical shape and tends to bead up rather than spreading out, which results in weaker adhesion and a lower bond strength between the liquid and the substrate surface. In contrast if the surface free energy of the liquid is less than the surface free energy of the substrate surface, the liquid will spread out and wet the substrate surface, resulting in greater adhesion and a higher bond strength due to the close contact between the liquid and the substrate surface.

Following treatment in accordance with the present disclosure, the surface free energy of the one or more treated sections of the substrate surface may be increased, as compared to the surface free energy of the one or more treated sections prior to treatment. In particular, a surface free energy of the one or more coatings may be less than the surface free energy of the treated sections, such that the one or more coatings may spread more easily across and wet the substrate surface comprising the one or more treated sections and may generally demonstrate stronger adhesion to the substrate surface comprising the one or more treated sections. In the case of a container, this stronger adhesion may translate to an increased joint bond strength.

In addition, altering the surface free energy of the substrate surface may alter a polarity of the substrate surface, which may further affect adhesion of the one or more coatings to the substrate surface comprising the one or more treated sections. A surface free energy of a surface comprises a total surface free energy that is a sum of a polar component and a dispersive component, in which the polar component comprises a portion of the surface free energy that is due to polar interactions that the surface is capable of having with a material applied to the surface. A percent polarity of a surface may be measured as a percentage of the total surface free energy comprising the polar component. In general, a surface that is substantially nonpolar (i.e., comprises a percent polarity of between 0% and 1%) may exhibit poor adhesion to a material with a greater percent polarity, and vice versa. Altering the percent polarity of the one or more treated sections of the substrate surface may allow a subsequent coating to spread more easily across and wet the substrate surface comprising the one or more treated sections, which may result in stronger adhesion of the coating to the one or more treated sections and an increased joint bond strength.

### Application of an Intermediate Coating

In some embodiments, treating the one or more sections of the substrate surface to alter the surface free energy may comprise applying an intermediate coating to the one or more sections of the substrate surface prior to application of the one or more (first) coatings, e.g., coating(s) 62. For ease of reference, the following discussion is provided with respect to the blank B, but it is understood that the substrate surface may also comprise the container 10 or any other suitable substrate surface.

With reference to FIG. 3, an intermediate coating 66A may be applied to a section of the substrate surface, i.e., the outer surface 44, comprising the bottom flap 34, which may be defined between an edge of the bottom flap 34 and the fold line 40. An intermediate coating 66B may also be applied to a section of the outer surface 44 comprising the top flap 24, which may be defined between an edge of the top flap 24 and the fold line 30. The coating 62B may then be applied over the intermediate coating 66A and 66B. As discussed in more detail below, one or more intermediate coatings, e.g., intermediate coatings 66C and/or 66D, may also be applied to one or more additional sections of the inner or outer surface 42, 44 of the blank B (intermediate coatings 66A to 66D may be referred to herein collectively as intermediate coating 66).

In some examples, the intermediate coating 66 may comprise, for example, one or more inks. The ink(s) may comprise a pigment and may be suitable for use in flexographic printing of cellulose-based substrate surfaces. The ink(s) may include, but are not limited to, Epic Black™, Edge Black™, Epic 75 Red™, and Edge 75 Red™ (International Paper Company; see also the Examples below). In some instances, the intermediate coating 66 may comprise one ink, and in other instances, the intermediate coating 66 may comprise two or more inks, which may be mixed prior to application or may be deposited simultaneously or sequentially. In other examples, the intermediate coating 66 may comprise one or more inks that may be substantially similar to the inks listed above, except that the one or more inks lack one or more pigments. In some instances, the ink(s) may lack all pigment and may be substantially clear.

In further examples, the intermediate coating 66 may comprise one or more other types of coatings. In some instances, the intermediate coating 66 may comprise an extender or a resin. The resin may comprise, for example, a cationic resin such as a styrenated acrylic resin with acrylic polymers. In some particular examples, these extender(s) and/or resin(s) may comprise one or more components of the ink(s) described herein. In other instances, the intermediate coating 66 may comprise, for example, one or more of a starch (including, without limitation, pearl, oxidized, acetylated, tapioca, wheat, rice, or ethylated), a barrier coating, polyurethane, alkyl ketene dimers (AKD), polyacrylate, polyethylene, alkylated melamine, a wax, a polyethylene emulsion, a glyoxylated crosslinker, a fluorochemical, an oil, one or more surface sizing agents such as styrene maleic anhydride (SMA), styrene acrylate emulsion (SAE), styrene acrylic acid (SAA), and/or ethylene acrylic acid (EAA), and a dry strength agent (e.g., an anionic acrylamide). In further instances, the intermediate coating may comprise one or more pigments (with and without binders (PVOH, PVAC, CMC, SBR, etc.)), including, but not limited to, clay, calcium carbonate, titanium dioxide, aluminum trihydrate, and calcined clay.

The intermediate coating 66 may cover all or part of the one or more sections of the substrate surface to which it is applied and may be applied in any desired color, color intensity, pattern, surface area density, etc. For example, a black ink may be applied so that a substrate surface section receiving the ink has a desired grayscale value, e.g., from 0 (black) to 255 (white) and/or has a desired surface area coverage percentage, e.g., pixel density/resolution varying from 0% (no ink applied to the surface section) to 100% (the entire surface section is covered with ink). FIGS. 5A to 5H are detailed, plan views of a portion of the blank B comprising the top flap 24 with an intermediate coating in accordance with the present disclosure, in which the top flap 24 may be representative of any one of the one of more sections of the substrate surface to which the intermediate coating 66 is applied (for purposes of the following discussion, the top flap 24 is referred to as “the substrate surface section”). In the examples shown in FIGS. 5A and 5F, the intermediate coating 66 may be applied across substantially an entirety of the substrate surface section and may cover, for example, about 90% to 100% of a surface area of the substrate surface section, in which the surface area is defined by a length L24 and a width W24 of the top flap 24. This percent coverage of the surface area includes all values and subranges therebetween, including, for example, 92%, 94%, 96%, and 98%.

With reference to FIGS. 5B to 5E, 5G, and 5H, in other examples, the intermediate coating 66 may be applied to only part of the substrate surface section. For instance, as shown in FIG. 5B, the intermediate coating 66 may be used to form an object or shape (e.g., by application of material to the substrate surface section), such as a logo or other text, a graphic image, etc., or to define an object or shape (e.g., by a lack of applied material), as shown in FIG. 5C. As shown in FIGS. 5D and 5E, the intermediate coating 66 may be applied to the substrate surface section in one or more patterns (stripes, checkerboard, etc.). With reference to FIGS. 5B to 5E, 5G, and 5H, in some instances, the intermediate coating 66 may be intermittently applied or applied only to a portion of the substrate surface section such that the intermediate coating 66 covers less than the entirety of the surface area of the substrate surface section. The intermediate coating 66 may cover, for example, between about 5% and about 90% of the surface area of the substrate surface section. This percent coverage of the surface area includes all values and subranges therebetween, including, for example, 10%, 15%, 20%, 25%, 30%, 35%, 40%, 45%, 50%, 55%, 60%, 65%, 70%, 75%, 80%, and 85%. For example, the intermediate coating 66 in FIGS. 5B, 5E, and 5G is applied such that about 50% of the surface area comprises the intermediate coating 66. In FIGS. 5D and 5H, about 75% of the surface area comprises the intermediate coating 66.

Following application of the intermediate coating 66, the one or more treated sections of the substrate surface may comprise a first surface free energy, and a subsequent coating, e.g., the coating 62, may comprise a second surface free energy that is less than the first surface free energy. For example, the untreated substrate surface may comprise a surface free energy of between about 28 and 32 dyne/cm, and the one or more treated sections of the substrate surface may comprise a surface free energy that is greater than or equal to about 35 dyne/cm and less than or equal to about 55 dyne/cm, and preferably between about 40 and 52 dyne/cm. In some particular examples, the surface free energy of the one or more treated sections of the substrate surface may be between about 10 and 20 dyne/cm greater than the surface free energy of the untreated substrate surface. In some instances, the surface free energy of the substrate surface prior to treatment may be substantially similar to the surface free energy of the coating 62.

In all examples, it is believed that the coating 62 may exhibit greater adhesion to the one or more sections of the substrate surface that have been treated by application of the intermediate coating 66. Prior to application of the intermediate coating 66, the substrate surface may comprise a surface free energy that is substantially similar to or less than the surface free energy of the coating 62. It is believed that by coating the one or more sections of the substrate surface with the intermediate coating 66 to increase the surface free energy prior to application of the coating 62, adhesion of the coating 62 to the one or more treated sections of the substrate surface may be increased.

In one particular example as shown in Table 1, the substrate may comprise a white top linerboard (International Paper Company), which is a cellulose-based substrate; the intermediate coating may comprise a black ink; and the coating may comprise a wax, such as a paraffin wax or a bio-based wax. The surface free energy properties of the untreated white top linerboard (i.e., uncoated or unaltered), wax-containing coatings, and an ink coating are measured, in which the wax-containing coatings and the ink coating are applied to and solidified on the white top linerboard. The results are listed below in Table 1 (see also the Examples below for additional details and sample preparation methods).

TABLE 1

| | | Surface Free Energy (dyne/cm) ± 95% CI | | | | | | | | | |
|---|---|---|---|---|---|---|---|---|---|---|---|
| | | | | | Dispersive | | | Polar | | | Polarity |
| No. | Sample | Total | | | Component | | | Component | | | % |
| 1 | White top linerboard | 28.2 | ± | 0.4 | 28.2 | ± | 0.4 | 0.0 | ± | 0.0 | 0.0 |
| | (untreated) #1 | | | | | | | | | | |
| 2 | White top linerboard | 30.2 | ± | 0.5 | 29.9 | ± | 0.5 | 0.2 | ± | 0.3 | 0.7 |
| | (untreated) #2 | | | | | | | | | | |
| 3 | Commercial paraffin | 34.9 | ± | 1.2 | 28.6 | ± | 0.6 | 6.3 | ± | 1.1 | 18.0 |
| | wax #1¹ | | | | | | | | | | |
| 4 | Bio-based wax² | 29.9 | ± | 0.4 | 29.0 | ± | 0.4 | 0.9 | ± | 0.2 | 3.0 |
| 5 | Black ink³ | 43.9 | ± | 0.5 | 43.9 | ± | 0.5 | 0.0 | ± | 0.0 | 0.0 |
| 6 | Commercial paraffin | 29.5 | ± | 0.8 | 28.9 | ± | 0.7 | 0.6 | ± | 0.3 | 2.0 |
| | wax #2⁴ | | | | | | | | | | |

¹IGI 7221A (International Group, Inc., 2018)
²Proprietary blend (Chemol Company, Inc.)
³Edge Black (International Paper Company)
⁴7207A (Masterank Wax Inc., 2018)

As seen in Table 1, the samples of the untreated white top linerboard (samples 1 and 2) comprise a surface free energy ranging between about 28 and 31 dyne/cm; the commercial paraffin wax #1 coating (sample 3) may comprise a surface free energy of between about 33 and 36 dyne/cm; the commercial paraffin wax #2 coating (sample 6) may comprise a surface free energy of between about 29 and 30 dyne/cm; and the bio-based wax coating (sample 4) may comprise a surface free energy of between about 30 and 31 dyne/cm. Commercial paraffin waxes may vary significantly in their total surface free energy and polarity, as seen by comparing samples 3 and 6, both of which were used industrially for box manufacturing in 2018. Comparing the commercial paraffin wax samples 3 and 6, sample 3 presents a greater challenge for strong adhesion to untreated whitetop linerboard (samples 1 and 2) due to sample 3 having a considerably higher surface free energy and polarity. Therefore, all discussion of paraffin wax coating herein is in regards to sample 3. As compared to the untreated white top linerboard samples and the wax coatings, the ink coating comprises a significantly higher surface free energy of between about 43.4 and 44.4 dyne/cm, see the black ink (sample 5).

The paraffin wax coating comprises a surface free energy that is about 5 dyne/cm greater than the surface free energy of the untreated white top linerboard, and the surface free energy and polarity of the bio-based wax coating is slightly greater than the surface free energy of the untreated white top linerboard. Thus, it is believed that the wax-containing coating may exhibit lower adhesion to the (unaltered) white top linerboard due to the lack of a significant difference between the surface free energies of the wax-containing coatings and the white top linerboard.

It is believed that a coating such as a wax-containing coating may exhibit greater adhesion to the white top linerboard following application of an ink coating, as described herein in more detail. The white top linerboard coated with ink, i.e., treated with ink, comprises a surface free energy that is between about 10 and 14 dyne/cm higher, as compared to the uncoated white top linerboard. The surface free energy of the ink-treated white top linerboard is higher than the surface free energy of the wax-containing coatings. Ink is generally known to adhere well to the white top linerboard, and due to the higher surface energy of the white top linerboard following coating with ink, it is believed that a wax-containing coating will adhere more strongly to the ink coating on the white top linerboard, as compared to the uncoated sections of the white top linerboard. Thus, it is believed that the wax-containing coating will exhibit greater adhesion to the treated sections of the white top linerboard (via the intermediate wax-containing coating), as compared to the untreated sections.

In addition, application of the intermediate coating 66 may alter the percent polarity of the treated section(s) of the substrate surface. In some examples as described herein, the untreated substrate surface may comprise a very low percent polarity (e.g., 0% to 1%), while the coating 62 may comprise a higher percent polarity (e.g., greater than 3%). In other examples, the untreated substrate surface may comprise a percent polarity that is higher than the percent polarity of the coating. It is believed that the difference in polarity between the untreated substrate surface and the coating 62, along with the lack of a significant difference in the surface free energy, may result in poor adhesion of the coating 62 to the untreated substrate surface.

In some instances, following application of the intermediate coating 66 in accordance with the present disclosure, the percent polarity of the one or more treated sections of the substrate surface may comprise a percent polarity that is different from the percent polarity of the untreated substrate surface. In some particular examples, the percent polarity of the intermediate coating 66 may fall between the values for the percent polarity of the untreated substrate surface and the percent polarity of the coating 62. For instance, the untreated substrate surface may be substantially nonpolar and may comprise a percent polarity of between about 0% and 1% (e.g., the white top linerboard in Table 1), while the coating 62 may be polar and may comprise a higher percent polarity, e.g., 3% for a coating comprising bio-based wax and 18% for a coating comprising paraffin wax (see Table 1). Thus, the intermediate coating 66 may comprise a percent polarity that falls between these values. For example, an intermediate coating 66 comprising a percent polarity that is greater than 0% and less than 3% may be selected for the bio-based wax, and an intermediate coating 66 comprising a percent polarity that is greater than 0% and less than 18% may be selected for the paraffin wax. In other instances, the untreated substrate surface may comprise a percent polarity that is higher than the percent polarity of the coating 62, and the intermediate coating 66 may comprise a percent polarity that falls between the percent polarity values for the untreated substrate surface and the coating 62.

It is generally believed that selection of an intermediate coating 66 with a percent polarity that falls between the values for the percent polarity of the untreated substrate surface and the coating 62 may help to mitigate the difference between the percent polarities by raising or lowering the percent polarity of the one or more treated sections of the substrate surface to a value that is closer to the percent polarity of the coating 62 (in addition to altering the surface free energy of the treated section(s) of the substrate surface), which may lead to better wetting of the treated substrate surface by a subsequent coating and increased adhesion of the coating to the treated substrate surface. However, it is generally believed that the effects of polar interactions may be secondary to the effects of surface free energy. For example, following application of Edge black ink (sample 5 in Table 1 above), the treated white top linerboard still comprises a percent polarity of 0%. It is believed that the significant difference in the surface free energy of the treated white top linerboard (about 44 dyne/cm) and the wax-containing coating (about 35 dyne/cm for the paraffin wax and about 30 dyne/cm for the bio-based wax) will at least partially overcome or override the difference in percent polarity to still achieve good adhesion of the wax to the treated white top linerboard.

### Additional Techniques to Treat the Substrate Surface

In other embodiments, treating the one or more sections of the substrate surface to increase adhesion of the one or more coatings, e.g., coating(s) 62, to the substrate surface may comprise subjecting the one or more sections of the substrate surface to one or more corona treatments to alter the surface free energy. Corona treatment is a surface modification technique in which a material is subjected to a high frequency corona discharge. With reference to FIG. 6A, a schematic diagram of a corona treatment apparatus 90 is shown. A substrate 80, which may comprise, for example, the blank B shown in FIG. 1, may be positioned on a fabric or belt 92, which may be driven by one or more driven rolls (not shown) in a direction indicated by arrow A past the corona treatment apparatus 90. The corona treatment apparatus 90 may comprise, for example, a grounded roll 94 (serves as a grounded electrode), a power source 96, and high voltage electrode 98. When power is supplied to the electrode 98, air between the electrode 98 and the grounded roll 94 is ionized to generate a low-temperature plasma. A substrate surface 80A of the substrate 80 may comprise a first surface free energy prior to corona treatment. As the substrate 80 passes below the electrode 98, the substrate 80 is bombarded with charged particles, which alters the surface free energy of the treated substrate surface 80A′. Following corona treatment, it is believed that the treated substrate surface 80A′ may comprise a second, different surface free energy, i.e., an increased surface free energy as compared to the substrate surface 80A prior to corona treatment. It is believed that corona treatment may also alter a polarity of the substrate surface 80A′. Although a single corona treatment apparatus 90 is depicted in FIG. 6A, it is understood that the substrate 80 may be subjected to two or more corona treatments by passing the substrate 80 past the electrode 98 multiple times and/or by treating the substrate 80 with additional corona treatment apparatuses (not shown). The one or more coatings, e.g., coating(s) 62, may then be applied to the substrate as described herein.

In further embodiments, in which the substrate comprises a cellulose-based substrate, treating the one or more sections of the substrate surface to increase adhesion of the one or more coatings, e.g., coating(s) 62, to the substrate surface may comprise mechanically abrading the one or more sections of the substrate surface. Mechanical abrasion may comprise, for example, scuffing the one or more sections of the substrate surface with a sanding roll (not shown). The one or more coatings, e.g., coating(s) 62, may then be applied to the substrate as described herein.

In still further embodiments, in which the substrate comprises a cellulose-based substrate, one or more additives may be introduced during manufacture of the substrate so as to increase adhesion of the one or more coatings, e.g., coating(s) 62, to the substrate surface. These additives, which are incorporated into the cellulose-based substrate during manufacture, are believed to be present throughout the substrate, including the surface, and are believed to affect surface properties such as surface free energy and/or polarity.

Forming an Article from a Treated Substrate

Following treatment of one or more sections of the substrate surface, e.g., one or more sections of the inner and/or outer surface 42, 44 of the blank B, in accordance with the present disclosure, an article, e.g., the container 10 in FIGS. 2A and 2B, may be formed from the substrate. With reference to FIGS. 1, 2A, and 2B, to begin forming the container 10, the lateral edges E₁ and E₂ of the blank B may be folded toward each other, and the panels 18B, 28B, and 38B may be joined to respective ones of the panels 18A, 28A, and 38A, e.g., by joining portions of the outer surface 44 comprising the panels 18B, 28B, and 38B to portions of the inner surface 42 comprising panels 18A, 28A, and 38A (joined panels 18A and 18B, 28A and 38B, and 38A, and 38B are referred to hereinafter as panels 18, 28, and 38, respectively). Bottom flaps 34 and 38 may be folded along the fold line 40 toward each other, and bottom flaps 32 and 36 may be folded along the fold line 40 toward each other and over the bottom flaps 34 and 38 to form a bottom 60 of the container 10. Top flaps 24 and 28 may similarly be folded along the fold line 30 toward each other, and top flaps 22 and 26 may be folded along the fold line 30 toward each other and over the top flaps 24 and 28 to form a top 58 of the container 10. The panels 12, 14, 16, and 18 may define four walls 50, 52, 54, and 56 of the container 10. The inner surface 42 of the blank B defines the inner surface of the container 10, and the outer surface 44 of the blank B defines the outer surface of the container 10.

Formation of the container 10 may generate one or more overlap areas where a portion of one of the inner surface 42 or the outer surface 44 overlaps an adjacent portion of the other of the inner surface 42 or the outer surface 44. In particular, as depicted in FIGS. 2A and 2B, the top flaps 22, 24, 26, and 28 may define overlap areas 23A, 23B, 27A, and 27B (shown with cross-hatching in FIG. 2B). In particular, the overlap areas 23A and 23B may be defined by a first portion 22-1 of the inner surface 42 comprising a section of the top flap 22 and a respective one of a second portion 24-1 or 28-1 of the outer surface 44 comprising sections of the top flaps 24 and 28. The overlap areas 27A and 27B may similarly be defined by a first portion 26-1 of the inner surface 42 comprising a section of the top flap 26 and a respective one of a second portion 24-2 and 28-2 of the outer surface 44 comprising sections of the top flaps 24 and 28. The bottom 60 of the container 10 may similarly comprise one or more overlap areas (not visible) formed by the bottom flaps 32, 34, 36, and 38, and the panels 18B, 28B, and 38B may form overlap areas (not shown) with respective ones of the panels 18A, 28A, and 28B.

One or more of the overlap areas may comprise an adhesive that is used to join the adjacent portions of the inner and outer surfaces 42 and 44. FIGS. 4A and 4B illustrate cross-sectional views taken along line 4-4 in FIG. 2B of a portion of a container 10 comprising an intermediate layer 66 (e.g., formed by application of the intermediate coating 66) in accordance with the present disclosure. With reference to FIGS. 2A and 4A, the top flap 26 may be adhered to the top flaps 24 and 28 via a coating of adhesive 64. In some examples, the adhesive 64 may be applied to a portion of the inner surface 42 that comprises the top flap 26, and in particular, to the first portion 26-1 of the top flap 24 that partially defines the overlap areas 27A and 27B, as shown in FIGS. 2A and 2B. Alternatively, the adhesive 64 may be applied to a portion of the outer surface 44 that comprises the portions 24-2 and 28-2 of the top flaps 24 and 28 that partially define the overlap areas 27A and 27B. The top flap 26 may then be folded over the top flaps 24 and 28 as described above, such that the first portion 26-1 of the top flap 26 overlaps and adheres to the second portions 24-2 and 28-2 of the top flaps 24 and 28. A joint 70 may be formed at the overlap area 27A between the first portion 26-1 and the second portion 24-2, and a joint 72 may be formed at the overlap area 27B between the first portion 26-1 and the second portion 28-2. In a further example shown in FIG. 4B, joints 70′ and 72′ may similarly be formed between the top flap 26 and adjacent portions of the top flaps 24 and 28.

A coating of adhesive (not shown) may similarly be applied to one or more portions of the inner or outer surface 42 and 44 comprising the portions 22-1, 24-1, and 28-1 of the top flaps 22, 24, and 28 that define the overlap areas 23A and 23B. The top flap 22 may then be folded over the top flaps 24 and 28 as described above, such that the first portion 22-1 of the top flap 22 overlaps and is adhered to the second portions 24-1 and 28-1 of the top flaps 24 and 28 to finish forming the top 58 of the container 10. Joints (not shown) may be formed at the overlap areas 23A and 23B between the first portion 22-1 and respective ones of the second portions 24-1 and 28-1. The lateral edges of the blank B and the bottom 60 of the container 10 may be formed in a similar manner by applying adhesive (not shown) to one or more portions of the inner and/or outer surface 42, 44 comprising the panels 18A, 18B, 28A, 28B, 38A, and 38B and to one or more portions of the inner and/or outer surface 42, 44 comprising the bottom flaps 32, 34, 36, and 38 and folding and joining the panels and flaps as described above, such that joints (not shown) are formed in overlap areas (not shown) where portions of the panels or flaps overlap one another. Containers in accordance with the present disclosure may be used to store and/or transport one or more products, including but not limited to, food items and landscaping supplies such as decorative stones and concrete pieces.

With reference to FIG. 4A, in some examples, the portion of the outer surface 44 comprising the top flap 24 may comprise the intermediate layer 66B; the portion of the outer surface 44 comprising the top flap 28 may comprise the intermediate layer 66C; the portion of the inner surface 42 comprising the top flap 26 may comprise the intermediate layer 66D; and layers 62A and 62B (e.g., formed by application of coatings 62A and 62B) may be located generally over the intermediate layers 66B to 66D. Thus, the joints 70 and 72 in FIG. 4A comprise a structure in which the intermediate layers 66B to 66D are in direct contact with the portions of the respective top flaps 24, 26, and 28; the layers 62A and 62B are located over, i.e., on top of, the intermediate layers 66B to 66D; and the layer of adhesive 64 is sandwiched between the layers 62A and 62B.

With reference to FIG. 4B, in other examples, the joints 70′ and 72′ may comprise only one layer 62 (e.g., formed by application of coating 62) located on a portion of the inner surface 44. More specifically, the portion of the outer surface 44 comprising the top flap 24 may comprise the intermediate layer 66B; the portion of the outer surface 44 comprising the top flap 28 may comprise the intermediate layer 66C; and the layer 62 may be located generally over the intermediate layers 66B and 66C. Thus, the joints 70′ and 72′ in FIG. 4B comprise a structure in which the intermediate layers 66B and 66C are in direct contact with the portions of the respective top flaps 24 and 28; the layer 62 is located over, i.e., on top of, the intermediate layers 66B and 66C; and the layer of adhesive 64 is in direct contact on one side with the portion of the inner surface 42 comprising the top flap 26 and on the other side with the layer 62.

The intermediate layer 66 may be applied to and positioned on all or part of the one or more sections of the substrate surface to which it is applied and may be applied in any desired color, color intensity, pattern, surface area coverage, etc., as illustrated in FIGS. 5A to 5H and described in detail herein. For purposes of the following discussion, the top flap 24 including the intermediate layer 66 in FIGS. 5A to 5H represent portions 24-1 and 24-2 of overlap areas 23A and 27A from FIG. 2B (referred to herein collectively as “the overlap area”; although not shown, an intermediate layer 66 may similarly be applied to portions 28-1 and 28-2 of the overlap areas 23B and 27B and/or to portions 22-1 and 26-1 of overlap areas 23A, 23B, 27A, and 27B from FIG. 2B in the manner shown in FIGS. 5A to 5H). In some instances, the adhesive may be applied to the overlap area such that the adhesive is generally coextensive with the intermediate layer 66, e.g., a shape and dimension of an outer perimeter of the coating of adhesive substantially corresponds to a shape and dimensions of an outer perimeter of the intermediate layer 66 and the adhesive covers substantially an entirety of the intermediate layer 66. For example, with reference to FIGS. 5A and 5G, a coating or film of adhesive (not separately labeled) may be applied across substantially an entirety of the intermediate layer 66 in a generally rectangular (FIG. 5A) or square (FIG. 5G) shape that substantially corresponds to the shape and dimensions of the outer perimeter of the intermediate layer 66.

In other instances, the adhesive may be applied to the overlap area such that at least a portion of the adhesive is contained within the intermediate layer 66, but the adhesive is not coextensive with the intermediate layer 66. For example, as shown in FIG. 5D, adhesive 64 may be applied in one or more beads or strips that are completely contained within, but are not coextensive with, the intermediate layer 66. In FIG. 5F, adhesive 64′ may similarly be applied in one or more beads or strips that are completely contained within, but not coextensive with, the intermediate layer 66. In FIG. 5D, by applying the intermediate layer 66 in stripes that substantially correspond to a placement of the beads/strips of adhesive 64, an amount of the intermediate layer 66 may be minimized, as compared to FIG. 5F, which may be useful in situations where adhesive application is tightly controlled and consistent. In situations where adhesive application is less tightly controlled, it may be desirable for the intermediate layer 66 to cover substantially an entirety of the overlap area as shown in FIG. 5F to ensure that the beads/strips of adhesive 64′ are applied to a portion of the overlap area comprising the intermediate layer 66. With reference to FIG. 5H, in further instances, the adhesive 64″ may be applied to the overlap area such that the adhesive 64″ is partially contained within the intermediate layer 66, with one or more portions of the adhesive 64″ being positioned on an untreated section of the overlap area.

FIG. 6B is a cross-sectional view similar to FIGS. 4A and 4B of a portion of an additional exemplary container 100, in which one or more sections of the substrate surface are treated in accordance with the present disclosure. The container 100 may be substantially similar to the containers 10 and 10′ depicted in FIGS. 2A, 2B, 4A, and 4B, and may comprise flaps 124, 126, and 128, which may substantially correspond to flaps 24, 26, and 28 that define overlap areas 27A and 27B. As shown in FIG. 6B, one or more sections of the substrate surface, i.e., the portions of the outer surface 44 (see FIGS. 1, 2A, and 2B) comprising portions 124-2 and 128-2 of the flaps 124 and 128, may be treated in accordance with the present disclosure, e.g., by corona treatment, introduction of additives, and/or mechanical abrasion, and a layer 162, e.g., ink coating, may be located over, i.e., on top of, the treated sections 124-2 and 128-2. The flaps 124, 126, and 128 may be folded and adhered to one another with a coating of adhesive 164, as described in detail above, to form joints 170 and 172. In the exemplary container 100 shown in FIG. 6, only sections 124-2 and 128-2 are treated, but it is understood that in some instances, the portion 126-1 of the inner surface 42 (see FIGS. 1, 2A, and 2B) comprising the flap 126 may also be treated. The adhesive may be applied as described above.

Articles made in accordance with known methods in which a coating, such as a coating containing a wax or other material, is applied directly to an (untreated) substrate surface frequently exhibit unacceptable levels of joint failure. As shown in Table 1, some wax-containing coatings comprise a surface free energy that is substantially similar to or higher than the surface free energy of the substrate surface of the substrate and/or a percent polarity that is different from the percent polarity of the substrate surface. With respect to cellulose-based substrates, it is commonly believed in the paper making industry that for such containers made using known methods, the adhesive penetrates through the wax-containing layer and contacts the substrate surface, such that joint failure is primarily due to separation of the adhesive from the substrate surface, with the wax-containing coating remaining attached to the substrate surface.

However, it is surprisingly found that the adhesive in these containers generally does not penetrate the wax-containing coating and that joint failure may be due, in large part, to separation of the wax-containing coating from the substrate surface, with the wax-containing coating remaining attached to the adhesive. For example, FIG. 7 is a photograph depicting a joint failure of a sample made using conventional methods and comprising two sections 150 and 152 of a white top linerboard substrate that are adhered together. The section 150 may represent, for example, flap 26 in FIG. 2A, with the (brown) inner surface 142 facing out of the page, and the section 152 may represent either of flaps 24 or 28 in FIG. 2A, with the (white) outer surface 144 facing out of the page. The outer surface 144 of the section 152 comprises a wax-containing coating (not separately labeled) that is applied directly to substantially an entirety of the outer surface 144 of the (unaltered) white top linerboard in accordance with known methods. The two sections 150 and 152 are adhered together via an adhesive 164, with the inner surface 142 of the section 150 facing the outer surface 144 of the section 152. The sections 150 and 152 are then pulled apart and separated as shown (see Example 7 for a description of preparation and testing of similar samples).

Upon separation of the sections 150 and 152, the adhesive layer 164 remains attached to the section 150, and it can be seen that a portion of the wax-containing coating adjacent to the adhesive 164 detaches cleanly from the outer surface 144 of the lower section 152, leaving a visible gap 165 in the wax-containing coating that substantially corresponds to a shape of the adhesive layer 164. The detached portion of the wax-containing coating remains attached to the adhesive layer 164. These findings and observations are confirmed by Fourier transform infrared (FTIR) spectroscopy and electron microscopy (not shown).

It is believed that treatment of one or more sections of the substrate surface prior to application of a coating, such as coating containing a wax or other material, as described herein results in better adhesion of the coating, e.g., wax-containing coating, to the treated sections of the substrate surface. In particular, it is believed that treating the substrate surface such that the surface free energy of the treated sections is greater than a surface free energy of the coating will result in an increased joint bond strength in containers made from substrates in accordance with the present disclosure.

FIGS. 8A and 8B are photographs that depict a joint failure of a sample made in accordance with the present disclosure and comprising two panels 200 and 202 of a white top linerboard substrate that are adhered together. The top panel 200 may represent, for example, flap 26 in FIG. 2A, with the (brown) inner surface 242 facing out of the page, and the bottom panel 202 may represent either of flaps 24 or 28 in FIG. 2A, with the (white) outer surface 244 facing out of the page. A section of the outer surface 244 of the panel 202 is treated in accordance with the present disclosure by applying an intermediate (black) layer 266 comprising an ink. A wax-containing coating (not separately labeled) is then applied to substantially an entirety of the outer surface 244 of the panel 202, including over the treated section comprising the intermediate layer 266 and over the untreated section of the panel 202. The two panels 200 and 202 are adhered together via an adhesive 264, with the inner surface 242 of the panel 200 facing the outer surface 244 of the panel 202. Thus, the panels 200 and 202 shown in FIG. 8A may substantially correspond to the structure depicted in FIG. 4B, and specifically to either of the joints 70′ or 72′ formed between the top flap 26 and either of flaps 24 or 28. The adhesive is applied in four strips 264A to 264D that each extend across a portion of the treated section of the panel 202 comprising the intermediate coating 266. The adhesive strips 264A to 264D also extend partially onto the untreated section of the panel 202 where the wax-containing coating is deposited directly onto the untreated white top linerboard. The panels 200 and 202 are then pulled apart and separated as shown (see Example 7 for a description of preparation and testing of similar samples).

In FIGS. 8A and 8B, it can be seen that the adhesive strips 264A to 264D remain attached to the panel 200. In the treated section of the panel 202 comprising the intermediate layer 266 of ink, a portion of fibers are torn from the inner surface 242 and remain attached to the adhesive strips 264A to 264D. Hence, it is believed that failure does not occur between the adhesive 264 and the wax-containing coating, between the wax-containing coating and the intermediate (black) layer 266, or between the intermediate layer 266 and the white top linerboard. Rather, it is believed that failure occurs within the fibers of the white top linerboard. As shown in FIG. 8B, which includes a detailed view of a portion of the panel 202, it can be seen that a portion of the wax-containing coating adjacent to the adhesive strips 264C and 264D detaches cleanly from the outer surface 244 in the areas where the adhesive strips 264C and 264D extend onto the untreated section of the panel 202. The detached portions of the wax-containing coating leave visible gaps 265 in the wax-containing coating that substantially correspond to a shape of the sections of the adhesive strips 264C and 264D positioned over the untreated section of the panel 202. The detached portions of the wax-containing coating remains attached to the respective adhesive strips 264C and 264D, as seen in FIG. 8A. Hence, similar to FIG. 7, it is believed that failure at the joint between the panel 200 and the untreated section of the panel 202 in FIGS. 8A and 8B occurs between the wax-containing coating and the outer surface 244 (untreated section) of the panel 202.

Table 2 lists the average bond strength of a joint that is formed between two panels of white top linerboard in accordance with known methods (e.g., a joint similar to that depicted in FIG. 7), as compared to a joint that is formed in accordance with the present disclosure (e.g., the joint 70′/72′ in FIG. 4B and a joint similar to the portion of FIGS. 8A and 8B comprising the intermediate layer 266). Example 7 contains a description of the sample preparation and testing.

TABLE 2

| | Avg. Glue Bead |
|---|---|
| Sample | Peel Test (lbf/in) |
| Bio-based wax with no ink | 0.8 ± 0.14 |
| Bio-based wax with full ink | 3.4 ± 0.48 |

As shown in Table 2, treatment of the substrate surface, e.g., by applying an ink that increases the surface free energy of the substrate surface, prior to applying the wax-containing layer significantly increases the bond strength of the joint from between about 0.66 and 0.94 lbf/in to between about 2.92 and 3.88 lbf/in.

The increased joint bond strength demonstrated by the joints formed in accordance with the present disclosure is believed to be due, at least in part, to increased adhesion of the wax-containing layer to the treated substrate surface. In particular, this increased adhesion is believed to be a result of the adhesion between the wax-containing layer and the intermediate layer comprising the ink and the adhesion of the intermediate layer comprising the ink to the substrate surface, in which the amount of adhesion between the wax-containing layer and the intermediate layer and the amount of adhesion between the intermediate layer and the substrate surface are individually greater than the amount of adhesion between the wax-containing layer and the (untreated) substrate surface.

Treatment of the one or more sections of the substrate surface prior to application of one or more subsequent coatings, e.g., a wax-containing coating, in accordance with the present disclosure generates a joint with a bond strength of between about 2.5 and 4.5 pounds of force per inch (lbf/in), and preferably at least about 2.7 lbf/in. The bond strength includes all values and subranges therebetween, including, for example, 2.9, 3.1, 3.3, 3.5, 3.7, 3.9, 4.1, and 4.3 lbf/in.

The increased adhesion of the wax-containing layer to the treated sections of the substrate surface may also help to avoid weakening and/or failure of joints due to softening of the wax in the wax-containing layer. Adhesives that may be used to assemble articles in accordance with the present disclosure, e.g., the container of FIGS. 2A and 2B, often comprise hot-melt adhesives. A portion of the wax-containing layer adjacent to the hot adhesive may soften due to heat imparted from the adhesive, which may cause joint failure shortly after application of the adhesive. In addition, the container 10 may be subjected to elevated temperatures, chemicals, and other environmental conditions during storage and/or transport that may cause the wax in the wax-containing layer to soften or melt, leading to weakened joints and/or joint failure.

For example, paraffin wax and paraffin wax blends, which may comprise a major softening temperature of between about 40 and 51° C., may be able to withstand higher temperatures for longer periods before joint failure occurs. However, bio-based wax, which may comprise a lower softening temperature of between about 33 and 37° C., may be at a greater risk for joint failure (see Example 6). It is believed that by treating the substrate surface prior to application of the wax-containing layer, the effects of elevated temperature may be mitigated, e.g., due to the increased adhesion of the wax-containing layer to the treated sections of the substrate surface, such that the amount of joint failure may be reduced in articles formed in accordance with the present disclosure.

It is believed that treatment of one or more sections of the substrate surface using one or more of the additional treatment methods described herein (e.g., corona treatment, and/or mechanical abrasion) may result in similar increases in joint bond strength for articles formed from the treated substrate.

It is surprisingly found that the mechanism of joint failure in coated containers is different from what is generally believed in the papermaking industry. In particular, it is commonly believed that the adhesive penetrates through the wax-containing layer and contacts the substrate surface and that joint failure is due to separation of the adhesive from the substrate surface, with the wax-containing layer remaining attached to the substrate surface. Thus, the solution to the perceived problem would appear to be increasing adhesion of the adhesive to the wax-containing layer or the substrate surface, with no need to alter adhesion of the wax-containing layer to the substrate surface.

However, it is surprisingly found that the adhesive does not penetrate the wax-containing layer and that joint failure is due, at least in part, to detachment of the wax-containing layer from the substrate surface. As described herein, treating one or more sections of the substrate surface to alter the surface free energy of the treated sections prior to application of the wax-containing layer is surprisingly found to result in increased bond strength in articles such as containers that are formed from the treated substrates. This increase in bond strength is believed to be due, at least in part, to increased adhesion of the wax-containing layer to the substrate surface via treatment of the substrate surface prior to receiving the wax-containing layer.

In particular, it is surprisingly found that the application of ink to one or more sections of the substrate surface alters the surface free energy of the treated sections of the substrate surface and leads to an increase in joint bond strength. While application of ink and other materials to substrates, particularly cellulose-based substrates, is known, it is generally standard practice in the papermaking industry to avoid intentional placement of significant amounts of ink in overlap areas, particularly ink comprising pigment(s), as these overlap areas are no longer visible following assembly of the container. Placement of significant amounts of ink in these areas in accordance with the present disclosure, particularly application of ink across substantially an entirety of the overlap areas, would generally be viewed as an unnecessary cost and a waste of resources that should be avoided. Other treatments disclosed herein (e.g., application of other types of coatings to the overlap areas, corona treatment, introduction of additives, and/or mechanical abrasion) may similarly be viewed as an unnecessary practice.

### EXAMPLES

### Example 1

### Determination of Surface Free Energy—White Top Linerboard

To obtain the samples listed in Table 1, white top linerboard (International Paper Company) is cut into panels. Edge black ink (International Paper Company) is applied to some of the panels using a two roll hand proofer that comprises a pyramid configuration, 180 line screen, with a billion cubic microns (BCM)/in² of 7.8. Paraffin and bio-based waxes are applied to other panels via curtain coating, in which the paraffin wax is heated to between about 93° C. and 110° C. and applied at a rate of about 5 to 8 lbs/MSF per side and the bio-based wax is heated to between 99° C. and 110° C. and applied at a rate of about 5.5 to 8 lbs/MSF.

To determine surface free energy (“dyne”), the contact angle is measured with water and with DIM (diiodomethane, also known as methylene iodide) according to Tappi T558 using the Fibro Dynamic Absorption Tester (DAT). After sample preconditioning and conditioning, the contact angle is measured at 0.1, 1.0, and 5.0 seconds. The drop volume is 4.0 μL for water, and 1.8 μL for DIM. The dispersive component of surface free energy is calculated for each individual DIM droplet from the DIM contact angle at 0.1 second. The average dispersive component is then used to calculate the polar component of surface free energy from the water contact angle, for each individual water droplet at 0.1 seconds. The Wu harmonic mean equation for solid-liquid interfacial tension is used for these calculations, in combination with Young's equation relating solid surface free energy, solid-liquid interfacial tension, liquid surface tension, and equilibrium solid-liquid contact angle. Along with contact angle, the Fibro DAT also calculates and reports droplet volume. Percent absorption at one second and at five seconds is determined for each individual droplet based on the decrease in its volume from that at 0.1 second.

The results of an initial surface free energy analysis are shown in Table 1 above, and the results of the contact angle analysis for some of these samples are shown below in Tables 3 and 4.

TABLE 3
Contact Angle for Water

| | No. | Contact Angle, Average ± 95% CI | | | | | | | | | % Absorption | |
|---|---|---|---|---|---|---|---|---|---|---|---|---|
| Sample | Drops | 100 ms | | | 1 sec | | | 5 sec | | | 1 sec | 5 sec |
| White top linerboard | 14 | 109.3 | ± | 2.0 | 109.0 | ± | 2.2 | 106.7 | ± | 2.7 | 0.4 | 1.1 |
| (untreated) #2 | | | | | | | | | | | | |
| Bio-based wax | 26 | 105.7 | ± | 0.8 | 105.8 | ± | 0.9 | 105.3 | ± | 0.8 | 0.2 | 0.7 |
| Black ink | 13 | 116.7 | ± | 1.1 | 109.0 | ± | 0.8 | 87.0 | ± | 1.4 | 0.3 | 1.7 |

TABLE 4
Contact Angle for DIM

| | No. | Contact Angle, Average ± 95% CI | | | | | | | | | % Absorption | |
|---|---|---|---|---|---|---|---|---|---|---|---|---|
| Sample | Drops | 100 ms | | | 1 sec | | | 5 sec | | | 1 sec | 5 sec |
| White top linerboard | 25 | 61.1 | ± | 0.9 | | | | | | | 9.5 | 42.8 |
| (untreated) #2 | | | | | | | | | | | | |
| Bio-based wax | 20 | 63.1 | ± | 0.7 | 62.3 | ± | 0.7 | 61.0 | ± | 0.9 | 0.2 | 0.7 |
| Black ink | 20 | 31.2 | ± | 1.2 | | | | | | | 0.3 | 1.7 |

As shown in Table 1 above, coating of the white top linerboard with ink results in a substrate surface with a higher surface free energy, as compared to the untreated white top linerboard. It is believed that this increase in surface free energy results in better wetting of the treated white top linerboard by a coating, such as wax-containing coating, that comprises a surface free energy that is similar to or higher than the untreated white top linerboard. Surface free energy analysis is conducted in accordance with the above techniques for several additional inks applied to panels of white top linerboard (International Paper Company). The results of this additional surface free energy analysis is shown in Table 5 (black ink), Table 6 (red ink), and Table 7 (clear ink, i.e., with no added pigment) below (data from the contact angle analysis is not shown). All inks are commercially available from International Paper Company.

TABLE 5
Black Ink on White Top Linerboard

| | | Surface Free Energy (dyne/cm) ± 95% CI | | | | | | | | | |
|---|---|---|---|---|---|---|---|---|---|---|---|
| | | | | | Dispersive | | | Polar | | | Polarity |
| Sample | pH | Total | | | Component | | | Component | | | % |
| AC9 GCMI 90 | 9.03 | 45.5 | ± | 0.3 | 45.2 | ± | 0.2 | 0.3 | ± | 0.2 | 0.6 |
| | 10.55 | 43.5 | ± | 0.5 | 43.5 | ± | 0.5 | 0.0 | ± | 0.0 | 0.0 |
| Bay Minette black | 8.3 | 45.4 | ± | 0.4 | 44.0 | ± | 0.3 | 1.4 | ± | 0.3 | 3.0 |
| | 10.32 | 45.2 | ± | 0.4 | 44.3 | ± | 0.3 | 0.9 | ± | 0.3 | 1.9 |
| Edge black | 9.15 | 44.6 | ± | 0.6 | 44.6 | ± | 0.6 | 0.0 | ± | 0.0 | 0.0 |
| | 10.47 | 44.6 | ± | 0.2 | 44.6 | ± | 0.2 | 0.0 | ± | 0.0 | 0.0 |
| Epic black | 8.96 | 45.2 | ± | 0.3 | 45.1 | ± | 0.3 | 0.1 | ± | 0.1 | 0.2 |
| | 10.34 | 45.5 | ± | 0.3 | 45.2 | ± | 0.3 | 0.3 | ± | 0.2 | 0.6 |
| HTFD-W black | 8.86 | 44.6 | ± | 0.6 | 39.1 | ± | 0.4 | 5.5 | ± | 0.4 | 12.3 |
| | 10.35 | 44.0 | ± | 0.5 | 39.5 | ± | 0.3 | 4.5 | ± | 0.4 | 10.3 |
| White top linerboard | | 30.7 | ± | 0.5 | 30.4 | ± | 0.4 | 0.3 | ± | 0.2 | 0.9 |
| (untreated) | | | | | | | | | | | |

TABLE 6
Red Ink on White Top Linerboard

| | | Surface Free Energy (dyne/cm) ± 95% CI | | | | | | | | | |
|---|---|---|---|---|---|---|---|---|---|---|---|
| | | | | | Dispersive | | | Polar | | | Polarity |
| Sample | pH | Total | | | Component | | | Component | | | % |
| Bay Minette 75 red | 8.76 | 42.3 | ± | 0.3 | 42.2 | ± | 0.3 | 0.1 | ± | 0.1 | 0.2 |
| | 10.33 | 42.1 | ± | 0.3 | 41.8 | ± | 0.3 | 0.3 | ± | 0.2 | 0.6 |
| Edge 75 red | 9.18 | 40.3 | ± | 0.5 | 38.5 | ± | 0.5 | 1.8 | ± | 0.2 | 4.4 |
| | 10.52 | 40.2 | ± | 0.5 | 38.5 | ± | 0.3 | 1.7 | ± | 0.3 | 4.3 |
| Epic 75 red | 9.26 | 42.1 | ± | 0.4 | 42.0 | ± | 0.4 | 0.1 | ± | 0.1 | 0.3 |
| | 10.57 | 42.2 | ± | 0.4 | 42.1 | ± | 0.4 | 0.0 | ± | 0.1 | 0.1 |
| GF 75 red | 9.30 | 40.9 | ± | 0.3 | 40.9 | ± | 0.3 | 0.0 | ± | 0.1 | 0.1 |
| | 10.57 | 41.1 | ± | 0.3 | 41.1 | ± | 0.3 | 0.0 | ± | 0.0 | 0.0 |
| HTFD-W 75 red | 9.08 | 45.9 | ± | 0.6 | 39.4 | ± | 0.4 | 6.5 | ± | 0.5 | 14.1 |
| | 10.27 | 46.4 | ± | 0.7 | 39.5 | ± | 0.3 | 6.9 | ± | 0.6 | 15.0 |

TABLE 7
Clear Ink on White Top Linerboard

| | Surface Free Energy (dyne/cm) ± 95% CI | | | | | | | | | |
|---|---|---|---|---|---|---|---|---|---|---|
| | | | | Dispersive | | | Polar | | | Polarity |
| Sample | Total | | | Component | | | Component | | | % |
| Bay Minette | 40.2 | ± | 0.4 | 39.9 | ± | 0.4 | 0.3 | ± | 0.2 | 0.7 |
| HTFD-W | 48.5 | ± | 0.6 | 40.0 | ± | 0.4 | 8.5 | ± | 0.5 | 17.5 |

As shown in Tables 5-7, coating of the white top linerboard with all of the inks results in a treated substrate surface with a significantly higher surface free energy, as compared to the untreated white top linerboard. It is believed that this increase in surface free energy will result in better wetting of the treated white top linerboard by a subsequent coating, such as a wax-containing coating, that comprises a surface free energy similar to or higher than the untreated white top linerboard, which may lead to better adhesion of the coating to the treated white top linerboard.

In addition, in some cases, application of the ink to the white top linerboard results in a treated substrate surface with a different percent polarity, as compared to the untreated white top linerboard. For example, coating the white top linerboard with Bay Minette black, HTFD-W black, Edge 75 red, HTFD-W 75 red, and HTFD-W (clear) results in a treated substrate surface with a percent polarity that is between about 3% and 17.5%. As discussed herein, it is believed that coating the substantially nonpolar white top linerboard with an ink that increases the percent polarity may help with bonding of a coating comprising a material such as a bio-based or paraffin wax that has a percent polarity that is higher than the untreated white top linerboard.

### Example 2

### Determination of Surface Free Energy—Kraft Liner

Similar tests are performed with a different substrate, brown kraft liner (International Paper Company). Samples are prepared and tested substantially as described above in Example 1 to determine surface free energy. The results are shown in Tables 8A and 8B (black ink), Tables 9A and 9B (red ink), and Tables 10A and 10B (clear ink, i.e., with no added pigment) below (data from the contact angle analysis is not shown). All inks are commercially available from International Paper Company.

TABLE 8A
Black Ink on Kraft Liner #1

| | | Surface Free Energy (dyne/cm) ± 95% CI | | | | | | | | | |
|---|---|---|---|---|---|---|---|---|---|---|---|
| | | | | | Dispersive | | | Polar | | | Polarity |
| Sample | pH | Total | | | Component | | | Component | | | % |
| AC9 GCMI 90 | 9.03 | 44.2 | ± | 0.7 | 44.2 | ± | 0.7 | 0.0 | ± | 0.0 | 0.0 |
| | 10.55 | 44.8 | ± | 0.3 | 44.8 | ± | 0.3 | 0.0 | ± | 0.0 | 0.0 |
| Bay Minette black | 8.30 | 42.5 | ± | 1.1 | 42.5 | ± | 1.1 | 0.0 | ± | 0.0 | 0.0 |
| | 10.32 | 42.2 | ± | 0.4 | 42.2 | ± | 0.4 | 0.0 | ± | 0.0 | 0.0 |
| Edge black | 9.15 | 43.5 | ± | 0.4 | 43.5 | ± | 0.4 | 0.0 | ± | 0.0 | 0.0 |
| | 10.47 | 43.1 | ± | 0.5 | 43.1 | ± | 0.5 | 0.0 | ± | 0.0 | 0.0 |
| Epic black | 8.96 | 45.3 | ± | 0.5 | 45.3 | ± | 0.5 | 0.0 | ± | 0.0 | 0.0 |
| | 10.34 | 45.2 | ± | 0.5 | 45.2 | ± | 0.5 | 0.0 | ± | 0.0 | 0.0 |
| HTFD-W black | 8.86 | 39.2 | ± | 0.5 | 38.9 | ± | 0.5 | 0.4 | ± | 0.2 | 0.9 |
| | 10.35 | 39.3 | ± | 0.5 | 38.4 | ± | 0.5 | 0.9 | ± | 0.3 | 2.2 |
| Kraft liner | | 42.6 | ± | 1.0 | 41.8 | ± | 0.9 | 0.8 | ± | 0.4 | 2.0 |
| (untreated) | | | | | | | | | | | |

TABLE 8B
Black Ink on Kraft Liner #2

| | Surface Free Energy (dyne/cm) ± 95% CI | | | | | | | | | |
|---|---|---|---|---|---|---|---|---|---|---|
| | | | | Dispersive | | | Polar | | | Polarity |
| Sample | Total | | | Component | | | Component | | | % |
| Edge black | 37.8 | ± | 0.3 | 37.8 | ± | 0.3 | 0.0 | ± | 0.0 | 0.0 |
| Epic black | 43.4 | ± | 0.3 | 43.4 | ± | 0.3 | 0.0 | ± | 0.0 | 0.0 |
| GCMI 90 | 33.2 | ± | 0.4 | 33.2 | ± | 0.4 | 0.0 | ± | 0.0 | 0.0 |
| GCMI 90-X | 42.3 | ± | 0.3 | 42.3 | ± | 0.3 | 0.0 | ± | 0.0 | 0.0 |
| AC9 GCMI 90 | 43.4 | ± | 0.3 | 43.4 | ± | 0.3 | 0.0 | ± | 0.0 | 0.0 |
| Kraft liner | 30.4 | ± | 0.5 | 30.4 | ± | 0.5 | 0.0 | ± | 0.0 | 0.0 |
| (untreated) | | | | | | | | | | |

TABLE 9A
Red Ink on Kraft Liner #1

| | | Surface Free Energy (dyne/cm) ± 95% CI | | | | | | | | | |
|---|---|---|---|---|---|---|---|---|---|---|---|
| | | | | | Dispersive | | | Polar | | | Polarity |
| Sample | pH | Total | | | Component | | | Component | | | % |
| Bay Minette 75 red | 8.76 | 39.2 | ± | 0.3 | 39.2 | ± | 0.3 | 0.0 | ± | 0.0 | 0.0 |
| | 10.33 | 39.1 | ± | 0.5 | 39.0 | ± | 0.5 | 0.1 | ± | 0.1 | 0.2 |
| Edge 75 red | 9.18 | 38.0 | ± | 0.5 | 37.7 | ± | 0.5 | 0.3 | ± | 0.2 | 0.7 |
| | 10.52 | 38.3 | ± | 0.5 | 37.9 | ± | 0.5 | 0.4 | ± | 0.3 | 1.1 |
| Epic 75 red | 9.26 | 41.0 | ± | 0.5 | 41.0 | ± | 0.5 | 0.0 | ± | 0.0 | 0.0 |
| | 10.57 | 40.9 | ± | 0.4 | 40.9 | ± | 0.4 | 0.0 | ± | 0.0 | 0.0 |
| | 9.30 | 38.2 | ± | 0.4 | 38.2 | ± | 0.4 | 0.0 | ± | 0.0 | 0.0 |
| GF 75 red | 10.57 | 38.6 | ± | 0.6 | 38.6 | ± | 0.6 | 0.0 | ± | 0.0 | 0.0 |
| HTFD-W 75 red | 9.08 | 41.9 | ± | 0.9 | 38.4 | ± | 0.7 | 3.5 | ± | 0.6 | 8.4 |
| | 10.27 | 42.7 | ± | 0.7 | 39.1 | ± | 0.5 | 3.6 | ± | 0.5 | 8.5 |

TABLE 9B
Red Ink on Kraft Liner #2

| | Surface Free Energy (dyne/cm) ± 95% CI | | | | | | | | | |
|---|---|---|---|---|---|---|---|---|---|---|
| | | | | Dispersive | | | Polar | | | Polarity |
| Sample | Total | | | Component | | | Component | | | % |
| Edge 75 red | 40.2 | ± | 1.0 | 38.8 | ± | 0.4 | 1.4 | ± | 0.9 | 3.4 |
| Epic 75 red | 39.4 | ± | 0.4 | 39.3 | ± | 0.4 | 0.1 | ± | 0.1 | 0.1 |
| GF 75 red | 37.9 | ± | 0.4 | 37.8 | ± | 0.4 | 0.1 | ± | 0.1 | 0.2 |
| Kraft liner | 30.4 | ± | 0.5 | 30.4 | ± | 0.5 | 0.0 | ± | 0.0 | 0.0 |
| (untreated) | | | | | | | | | | |

TABLE 10A
Clear Ink on Kraft Liner #1

| | Surface Free Energy (dyne/cm) ± 95% CI | | | | | | | | | |
|---|---|---|---|---|---|---|---|---|---|---|
| | | | | Dispersive | | | Polar | | | Polarity |
| Sample | Total | | | Component | | | Component | | | % |
| Bay Minette | 36.2 | ± | 0.3 | 36.2 | ± | 0.3 | 0.0 | ± | 0.1 | 0.1 |
| HTFD-W | 42.7 | ± | 1.0 | 38.6 | ± | 0.9 | 4.1 | ± | 0.4 | 9.6 |

TABLE 10B
Clear Ink on Kraft Liner #2

| | Surface Free Energy (dyne/cm) ± 95% CI | | | | | | | | | |
|---|---|---|---|---|---|---|---|---|---|---|
| | | | | Dispersive | | | Polar | | | Polarity |
| Sample | Total | | | Component | | | Component | | | % |
| Edge | 38.1 | ± | 0.7 | 37.3 | ± | 0.5 | 0.8 | ± | 0.5 | 2.2 |
| Epic | 37.6 | ± | 0.7 | 37.2 | ± | 0.6 | 0.4 | ± | 0.3 | 1.0 |
| LMV 7050 | 39.2 | ± | 1.2 | 38.3 | ± | 0.9 | 0.9 | ± | 0.8 | 2.2 |
| 2700 | 40.7 | ± | 0.7 | 39.7 | ± | 0.5 | 1.0 | ± | 0.4 | 2.4 |
| 4035 | 40.1 | ± | 1.5 | 36.7 | ± | 1.0 | 3.4 | ± | 1.2 | 8.4 |
| Kraft liner | 30.4 | ± | 0.5 | 30.4 | ± | 0.5 | 0.0 | ± | 0.0 | 0.0 |
| (untreated) | | | | | | | | | | |

In the examples set out in Tables 8A, 9A, and 10A, it is noted that the untreated kraft liner comprises a surface free energy of 42.6 dyne/cm, which is higher than the surface free energy of the white top linerboard and some of the inks (see Tables 1 and 5-7), and a percent polarity of 2%, which is slightly higher than that of the white top linerboard. Tables 8B, 9B, and 10B include untreated kraft liner with a surface free energy of 30.4 dyne/cm and 0% polarity. In general, due to differences in manufacturing and/or composition, it is believed that samples of kraft liner exhibit a wider range of values (as compared to the white top linerboard) for surface free energy and percent polarity, e.g., about 27 dyne/cm to about 43 dyne/cm for surface free energy and percent polarities of 0% to about 9%. It is believed that the examples set out in Tables 8B, 9B, and 10B represent more typical values for the surface free energy and polarity of kraft liner. For kraft liner samples with a higher surface energy and/or percent polarity prior to treatment (e.g., Tables 8A, 9A, and 10A), it is believed that application of ink prior to application of the wax-containing coating may still lead to better adhesion of the wax-containing coating to the treated kraft liner. For kraft liner samples with a lower surface free energy and percent polarity prior to treatment (e.g., Tables 8B, 9B, and 10B with values closer to the white top linerboard in Tables 1 and 5), application of ink prior to application of the wax-containing coating increases the surface free energy of the treated kraft liner (with or without a change in percent polarity), which may result in an increase in adhesion of the wax-containing coating to the treated kraft liner as described herein.

### Example 3

### Determination of Surface Free Energy—Ink Components

Similar tests are performed with the white top linerboard (International Paper Company) and different treatments/coatings. In particular, several extenders and other ink components used in the inks tested in Examples 1 and 2 are applied individually to the white top linerboard and the surface free energy is measured, as describe in Example 1. The results are shown in Table 11 (data from the contact angle analysis is not shown).

TABLE 11
Ink Components on White Top Linerboard

| | Surface Free Energy, dyne/cm | | | | | | | | | |
|---|---|---|---|---|---|---|---|---|---|---|
| | | | | Dispersive | | | Polar | | | Polarity |
| Sample | Total | | | Component | | | Component | | | % |
| Extender 464 | 39.1 | ± | 0.4 | 38.1 | ± | 0.3 | 1.0 | ± | 0.3 | 2.6 |
| Clear Grip | 45.5 | ± | 0.5 | 38.9 | ± | 0.4 | 6.6 | ± | 0.4 | 14.5 |
| Epic Extender | 42.1 | ± | 0.5 | 40.1 | ± | 0.3 | 2.1 | ± | 0.3 | 4.9 |
| Edge Extender | 45.5 | ± | 0.6 | 38.7 | ± | 0.3 | 6.8 | ± | 0.5 | 14.9 |
| EMUL 4035 | 51.7 | ± | 1.0 | 40.4 | ± | 0.5 | 11.4 | ± | 0.9 | 21.9 |
| HS 2700 Resin | 48.5 | ± | 0.6 | 42.8 | ± | 0.4 | 5.7 | ± | 0.5 | 11.7 |
| EMUL 7050 | 44.4 | ± | 0.6 | 40.3 | ± | 0.5 | 4.1 | ± | 0.4 | 9.2 |
| White top linerboard | 28.2 | ± | 0.4 | 28.2 | ± | 0.4 | 0.0 | ± | 0.0 | 0.0 |
| (untreated) | | | | | | | | | | |

As shown in Table 11, all of the ink components increase the surface free energy of the white top linerboard, with resins such as HS 2700 Resin and EMUL 4035 exhibiting the greatest increase in surface free energy. The ink components also increase the percent polarity of the treated white top linerboard. As described above, it is believed that these changes in surface free energy and/or percent polarity may help to increase adhesion of coatings, such as a wax-containing coating, to the treated white top linerboard.

### Example 4

### Microscopy Analysis

Several of the samples from Examples 1 and 2 are observed under electron microscopy. FIG. 9 includes electron micrographs of a portion (A) of the untreated white top linerboard and a portion (B) of the white top linerboard following application of Edge black ink (e.g., from Tables 1 and 5) at 200× magnification. As seen in FIG. 9, there is a significant reduction in surface porosity when the black ink is applied to the white top linerboard, with very little to none of the white surface being visible through the ink. These observations are confirmed at higher magnification (5,000×; not shown), in which the ink particles can be seen covering the cellulose/calcium carbonate on the surface of the coated white top linerboard.

FIG. 10 includes electron micrographs of a portion (A) of the untreated kraft paper and a portion (B) of the kraft paper following application of Edge black ink (e.g., from Table 8) at 200× magnification. At the magnification shown in FIG. 10, surface porosity appears to be reduced by a small amount when the black ink is applied to the kraft paper, with the (brown) kraft paper being visible through the coating of black ink. At higher magnification (5,000×; not shown), the effects of the ink coating on the porosity are more marked, with the coated kraft paper exhibiting a more uniform texture.

### Example 5

### Wax Coating Thickness

A thickness of a coating of the bio-based wax is measured on the untreated (e.g., no ink) vs. treated (e.g., following application of a coating of Edge black ink) white top linerboard and kraft paper substrates. The results are summarized in Table 12 below.

TABLE 12
Coating Thickness Measurements

| | Thickness (μm) | | | |
|---|---|---|---|---|
| Sample | | | Std. Dev. | 95% CI |
| White top linerboard (untreated) | 34.0 | ± | 5.1 | 2.4 |
| White top linerboard (treated) | 37.7 | ± | 3.3 | 1.5 |
| Kraft paper (untreated) | 31.3 | ± | 3.3 | 1.5 |
| Kraft paper (treated) | 35.3 | ± | 3.4 | 1.6 |

As shown in Table 12, the thickness of the wax coating is significantly higher for the treated substrate, as compared to the untreated substrate, for both the white top linerboard and the kraft paper. This increase in thickness of the wax coating is believed to be due, at least in part, to the reduction in porosity of the treated substrate surface due to the presence of the ink coating.

### Example 6

### Determination of Thermal Properties of the Waxes

Thermal properties of several waxes are determined using Differential Scanning Calorimetry (DSC). A small sample of the wax is placed in an aluminum pan, then heated and cooled in a nitrogen atmosphere using the following thermal conditions:

Heat from -25° C. to 150° C. at 10° C./min

Isothermal hold at 150° C. for 1 min

Cool from 150° C. to -25° C. at 10° C./min

Reheat from −25° C. to 150° C. at 10° C./min

The results of the DSC analysis are shown in Table 13 below.

TABLE 13
DSC Analysis

| No. | Wax | Onset (° C.) | Width (° C.) | Peak (° C.) |
|---|---|---|---|---|
| 1 | MasterRank 180CW¹ | 51 | 9 | 62 |
| 2 | IGI R6741C² | 47 | 9 | 59 |
| 3 | Bio-based wax³ | 37 | 6 | 45 |

¹Masterank Wax, Inc.
²International Group, Inc.
³Proprietary blend (Chemol Company, Inc.)

As shown in Table 13, the bio-based wax (sample 3) comprises a lower softening (onset) and melting (peak) temperatures, as compared to the paraffin-based waxes (samples 1 and 2).

### Example 7

### Determination of Joint Bond Strength

To obtain the samples listed in Table 2, panels of white top linerboard (International Paper Company) are cut, and Edge black ink (International Paper Company) is applied to a portion of an outer surface (i.e., the white top surface as depicted in FIGS. 8A and 8B) of some of the panels. Bio-based wax is then applied to all sections of the white top linerboard via curtain coating as described in Example 1. A bead of Reynold's Waxmaster hot melt adhesive is applied (target bead size of about 9.5 mm in diameter) to the outer surface of the panel across a width of the panel, and pairs of panels are adhered together, with the inner (brown) surface of one panel facing the outer (white) surface of the other panel. The samples comprise: (i) a wax-coated panel bonded to another wax-coated panel (no ink coating; similar to FIG. 7); and (ii) a wax-coated panel bonded to a panel that is coated with ink prior to coating with wax (similar to FIGS. 8A and 8B). Similar to the examples depicted in FIGS. 8A and 8B, for the ink-coated panel, the majority of the adhesive is located over the ink-coated portion of the panel, with a portion of the bead of adhesive extending slightly beyond the ink-coated portion and onto the adjacent portion of the panel that comprises only the wax coating.

The adhered samples are then subjected to a bead peel test using a Model 5500R2OUD Tensile Tester (Instron® Corp.) to measure the strength of the joints between the adhesively-bonded panels of white top linerboard. The results are summarized in Table 2, which illustrates a significant increase in joint bond strength for the white top linerboard that is coated with ink vs. the untreated white top linerboard.

As used throughout, ranges are used as a short hand for describing each and every value that is within the range, including all subranges therein.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A method comprising:
providing a substrate comprising a substrate surface with a first surface free energy;
treating one or more sections of the substrate surface by applying a coating comprising one or more of an ink or at least one ink component; and
applying a wax coating to at least one of the one or more treated sections of the substrate surface, wherein the wax coating comprises a second surface free energy and wherein the coating comprising one or more of an ink or at least one ink component comprises a third surface free energy that is greater than the second surface free energy such that treating the one or more sections of the substrate surface increases adhesion of the wax coating to the treated sections of the substrate surface.

2. The method of claim 1, wherein the substrate comprises a cellulose-based substrate.

3. The method of claim 1, wherein the one or more ink components comprise one or more of an extender and a resin.

4. The method of claim 1, wherein:
the first surface free energy comprises a first total surface free energy that is a sum of a first polar component and a first dispersive component, wherein a first percent polarity is a percentage of the first total surface free energy comprising the first polar component;
the second surface free energy comprises a second total surface free energy that is a sum of a second polar component and a second dispersive component, wherein a second percent polarity is a percentage of the second total surface free energy comprising the second polar component; and
the third surface free energy comprises a third total surface free energy that is a sum of a third polar component and a third dispersive component, wherein a third percent polarity is a percentage of the third total surface free energy comprising the third polar component,
wherein the second percent polarity is between the first percent polarity and the third percent polarity.

5. The method of claim 1, wherein the substrate comprises a cellulose-based substrate with an inner surface, an outer surface, and one or more overlap areas, wherein each of the one or more overlap areas is defined by a first portion of one of the inner surface or the outer surface that overlaps with a second portion of the other of the inner surface or the outer surface, wherein the one or more sections comprise at least one of the first or the second portion of the one or more overlap areas.

6. The method of claim 5, wherein the coating comprising one or more of an ink or at least one ink component is applied to substantially an entirety of the at least one of the first or the second portion of the one or more overlap areas.

7. The method of claim 5, further comprising:
following application of the wax coating, applying an adhesive coating to one of the first or the second portion of at least one of the one or more overlap areas.

8. The method of claim 7, further comprising:
following application of the adhesive coating, folding the substrate such that the one of the first or the second portion of the at least one overlap area comprising the adhesive coating overlaps and adheres to the other of the first or the second portion of the at least one overlap area to form a joint,
wherein a bond strength of the joint is greater than about 2.5 pounds of force per inch.

9. The method of claim 5, wherein the wax coating covers substantially an entirety of at least one of the inner surface or the outer surface.

10. The method of claim 1, wherein the second surface free energy is substantially similar to or less than the first surface free energy.

11. The method of claim 1, wherein the wax coating comprises a bio-based wax, a paraffin wax, or blends thereof.

12. The method of claim 1, wherein treating the one or more sections of the substrate surface further comprises mechanically abrading the one or more sections of the substrate surface.

13. An article comprising:
a substrate comprising a substrate surface, wherein one or more sections of the substrate surface are treated by applying a layer comprising one or more of an ink or at least one ink component; and
a wax layer positioned on at least one of the one or more treated sections of the substrate surface, wherein:
the substrate surface comprises a first surface free energy prior to treatment;
the wax coating comprises a second surface free energy; and
the coating comprising one or more of an ink or at least one ink component comprises a third surface free energy that is greater than the second surface free energy such that treating the one or more sections of the substrate surface increases adhesion of the wax coating to the treated sections of the substrate surface.

14. The article of claim 13, wherein the substrate comprises a cellulose-based substrate.

15. The article of claim 13, wherein the one or more ink components comprise one or more of an extender and a resin.

16. The article of claim 13, wherein:
the first surface free energy comprises a first total surface free energy that is a sum of a first polar component and a first dispersive component, wherein a first percent polarity is a percentage of the first total surface free energy comprising the first polar component;
the second surface free energy comprises a second total surface free energy that is a sum of a second polar component and a second dispersive component, wherein a second percent polarity is a percentage of the second total surface free energy comprising the second polar component; and
the third surface free energy comprises a third total surface free energy that is a sum of a third polar component and a third dispersive component, wherein a third percent polarity is a percentage of the third total surface free energy comprising the third polar component,
wherein the second percent polarity is between the first percent polarity and the third percent polarity.

17. The article of claim 13, wherein the substrate comprises a cellulose-based substrate with an inner surface, an outer surface, and one or more overlap areas, wherein each of the one or more overlap areas is defined by a first portion of one of the inner surface or the outer surface that overlaps with a second portion of the other of the inner surface or the outer surface, wherein the one or more sections comprise at least one of the first or the second portion of the one or more overlap areas.

18. The article of claim 17, wherein the layer comprising one or more of an ink or at least one ink component is positioned on substantially an entirety of the at least one of the first or the second portion of the one or more overlap areas.

19. The article of claim 17, further comprising an adhesive layer positioned on one of the first or the second portion of at least one of the one or more overlap areas and located on top of the wax layer.

20. The article of claim 19, further comprising one or more joints formed by the one of the first or the second portion of the at least one overlap area comprising the adhesive layer that overlaps and adheres to the other of the first or the second portion of the at least one overlap area,
wherein a bond strength of the joint is greater than about 2.5 pounds of force per inch.

21. The article of claim 17, wherein the wax layer is positioned on substantially an entirety of at least one of the inner surface or the outer surface.

22. The article of claim 13, wherein the second surface free energy is substantially similar to or less than the first surface free energy.

23. The article of claim 13, wherein the wax layer comprises a bio-based wax, a paraffin wax, or blends thereof.

24. The article of claim 13, wherein treatment of the one or more sections of the substrate surface further comprises mechanically abrading the one or more sections of the substrate surface.
